(19) United States
(12) Patent Application Publication
(10) Pub. No.: US 2011/0040070 A1
(43) Pub. Date: Feb. 17, 2011

(54) ISOTACTIC POLY(ALKYLENE OXIDE) AND PRODUCTION PROCESS THEREOF

(75) Inventor: Masaaki NABIKA, Ichihara-shi (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SUMITOMO CHEMICAL COMPANY, LIMITED, Tokyo (JP)

(21) Appl. No.: 12/848,402

(22) Filed: Aug. 2, 2010

(30) Foreign Application Priority Data
Aug. 12, 2009 (JP) 2009-187175

(51) Int. Cl. C08G 65/12

(52) U.S. Cl. 528/412

(57) ABSTRACT

An isotactic poly(alkylene oxide) containing the defined repeating unit, and having an isotactic triad fraction of 66 to 100%, and number-average molecular weight of 500,000 or more; and a production process thereof, comprising the step of polymerizing an epoxide represented by the defined formula in the presence of a catalyst and an aliphatic compound and/or alicyclic compound.

### FIELD OF THE INVENTION

The present invention relates to a high-molecular-weight isotactic poly(alkylene oxide), and a process for producing such an isotactic poly(alkylene oxide).

### BACKGROUND OF THE INVENTION

It is known in these years that propylene oxide is homopolymerized with use of a cobalt complex, thereby obtaining a highly stereoregular poly(propylene oxide). For example, US 2006-0293501A (corresponding to U.S. Pat. No. 7,399,822B) discloses that propylene oxide is polymerized with use of a cobalt complex having a ligand of N,N′-bis(3,5-di-tert-butylsalicylidene)-benzenediamine, thereby obtaining a crystalline isotactic poly(propylene oxide).

### SUMMARY OF THE INVENTION

However, the above poly(propylene oxide) has such low molecular weight that a high-molecular-weight poly(propylene oxide) is needed for a variety of uses.

In view of the above circumstances, the present invention has an object to provide a high-molecular-weight isotactic poly(alkylene oxide), and a process for producing such an isotactic poly(alkylene oxide).

The present invention is an isotactic poly(alkylene oxide) containing a repeating unit represented by following formula (1), and having an isotactic triad fraction (mm) of 66 to 100% measured by ¹³C-nuclear magnetic resonance analysis (¹³C-NMR), and number-average molecular weight (Mn) of 500,000 or more:

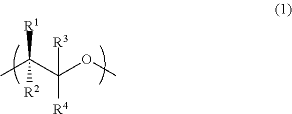

wherein R¹ and R² are a hydrogen atom or a hydrocarbyl group having 1 to 20 carbon atoms, and are different from each other; and R³ and R⁴ are independently of each other a hydrogen atom or a hydrocarbyl group having 1 to 20 carbon atoms.

Also, the present invention is a process for producing an isotactic poly(alkylene oxide) containing a repeating unit represented by above formula (1), and having an isotactic triad fraction (mm) of 66 to 100% measured by ¹³C-nuclear magnetic resonance analysis (¹³C-NMR), and number-average molecular weight (Mn) of 500,000 or more, the process comprising the step of polymerizing an epoxide represented by following formula (2) in the presence of a catalyst and an aliphatic compound and/or alicyclic compound:

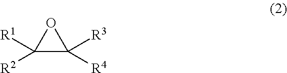

wherein R¹ to R⁴ are the same as those defined above.

### DETAILED DESCRIPTION OF THE INVENTION

Stereoregularity of the isotactic poly(alkylene oxide) of the present invention can be measured by ¹³C-nuclear magnetic resonance analysis (¹³C-NMR). For example, stereoregularity of poly(propylene oxide) is disclosed in detail in “Macromolecules, Vol. 19, No. 5, pages 1337-1343, (September, 1986)” edited by American Chemical Society, and is measured generally based on an integrated value of its methine carbon.

As is well known to those skilled in the art, the higher stereoregularity of a polymer is, the more excellent its crystallinity is. The isotactic poly(alkylene oxide) of the present invention has an isotactic triad fraction (mm), measured by ¹³C-nuclear magnetic resonance analysis (¹³C-NMR), of 66% or more; preferably 81% or more, for example, from a viewpoint of a film application; more preferably 90% or more; and further preferably 99% or more.

Examples of the hydrocarbyl group having 1 to 20 carbon atoms of R¹, R², R³ and R⁴ in above formula (1) are an alkyl group having 1 to 20 carbon atoms, an aralkyl group having 7 to 20 carbon atoms, and an aryl group having 6 to 20 carbon atoms. The hydrocarbyl group may have a substitution group. Examples of the substitution group are a halogen atom such as a fluorine atom, a chlorine atom, a bromine atom and an iodine atom; an alkoxy group such as a methoxy group and an ethoxy group; an aryloxy group such as a phenoxy group; and an aralkyloxy group such as a benzyloxy group.

Examples of the above alkyl group having 1 to 20 carbon atoms are a methyl group, an ethyl group, a n-propyl group, an isopropyl group, a n-butyl group, a sec-butyl group, a tert-butyl group, a n-pentyl group, a neopentyl group, an isoamyl group, a n-hexyl group, a n-octyl group, a n-decyl group, a n-dodecyl group, a n-pentadecyl group, and an eicosyl group. Among them, preferred is a methyl group or an ethyl group.

Examples of the alkyl group having 1 to 20 carbon atoms substituted with a halogen atom are a fluoromethyl group, a difluoromethyl group, a trifluoromethyl group, a chloromethyl group, a dichloromethyl group, a trichloromethyl group, a bromomethyl group, a dibromomethyl group, a tribromomethyl group, an iodomethyl group, a diiodomethyl group, a triiodomethyl group, a fluoroethyl group, a difluoroethyl group, a trifluoroethyl group, a tetrafluoroethyl group, a pentafluoroethyl group, a chloroethyl group, a dichloroethyl group, a trichloroethyl group, a tetrachloroethyl group, a pentachloroethyl group, a bromoethyl group, a dibromoethyl group, a tribromoethyl group, a tetrabromoethyl group, a pentabromoethyl group, a perfluoropropyl group, a perfluorobutyl group, a perfluoropentyl group, a perfluorohexyl group, a perfluorooctyl group, a perfluorododecyl group, a perfluoropentadecyl group, a perfluoroeicosyl group, a perchloropropyl group, a perchlorobutyl group, a perchloropentyl group, a perchlorohexyl group, a perchlorooctyl group, a perchlorododecyl group, a perchloropentadecyl group, a perchloroeicosyl group, a perbromopropyl group, a perbromobutyl group, a perbromopentyl group, a perbromohexyl group, a perbromooctyl group, a perbromododecyl group, a perbromopentadecyl group, and a perbromoeicosyl group.

Examples of the above aralkyl group having 7 to 20 carbon atoms are a benzyl group, a (2-methylphenyl)methyl group, a (3-methylphenyl)methyl group, a (4-methylphenyl)methyl group, a (2,3-dimethylphenyl)methyl group, a (2,4-dimethylphenyl)methyl group, a (2,5-dimethylphenyl)methyl group, a (2,6-dimethylphenyl)methyl group, a (3,4-dimethylphenyl)methyl group, a (3,5-dimethylphenyl)methyl group, a (2,3,4-trimethylphenyl)methyl group, a (2,3,5-trimethylphenyl)methyl group, a (2,3,6-trimethylphenyl)methyl group, a (3,4,5-trimethylphenyl)methyl group, a (2,4,6-trimethylphenyl)methyl group, a (2,3,4,5-tetramethylphenyl)methyl group, a (2,3,4,6-tetramethylphenyl)methyl group, a (2,3,5,6-tetramethylphenyl)methyl group, a (pentamethylphenyl)methyl group, an (ethylphenyl)methyl group, a (n-propylphenyl)methyl group, an (isopropylphenyl)methyl group, a (n-butylphenyl)methyl group, a (sec-butylphenyl)methyl group, a (tert-butylphenyl)methyl group, a (n-pentylphenyl)methyl group, a (neopentylphenyl)methyl group, a (n-hexylphenyl)methyl group, a (n-octylphenyl)methyl group, a (n-decylphenyl)methyl group, a (n-tetradecyphenyl)methyl group, a naphthylmethyl group, and an anthracenylmethyl group. Among them, preferred is a benzyl group.

Examples of the above aryl group having 6 to 20 carbon atoms are a phenyl group, a 2-tolyl group, a 3-tolyl group, a 4-tolyl group, a 2,3-xylyl group, a 2,4-xylyl group, a 2,5-xylyl group, a 2,6-xylyl group, a 3,4-xylyl group, a 3,5-xylyl group, a 2,3,4-trimethylphenyl group, a 2,3,5-trimethylphenyl group, a 2,3,6-trimethylphenyl group, a 2,4,6-trimethylphenyl group, a 3,4,5-trimethylphenyl group, a 2,3,4,5-tetramethylphenyl group, a 2,3,4,6-tetramethylphenyl group, a 2,3,5,6-tetramethylphenyl group, a pentamethylphenyl group, an ethylphenyl group, a n-propylphenyl group, an isopropylphenyl group, a n-butylphenyl group, a sec-butylphenyl group, a tert-butylphenyl group, a n-pentylphenyl group, a neopentylphenyl group, a n-hexylphenyl group, a n-octylphenyl group, a n-decylphenyl group, a n-dodecylphenyl group, a n-tetradecylphenyl group, a naphthyl group, and an anthracenyl group. Among them, preferred is a phenyl group.

The repeating unit represented by formula (1) is preferably a repeating unit wherein R³ and R⁴ are a hydrogen atom; more preferably a repeating unit wherein R¹ or R² is a hydrogen atom, and R³ and R⁴ are a hydrogen atom; and further preferably a repeating unit wherein R¹ is a methyl group, R² is a hydrogen atom, and R³ and R⁴ are a hydrogen atom, or a repeating unit wherein R¹ is a hydrogen atom, R² is a methyl group, and R³ and R⁴ are a hydrogen atom.

Examples of the isotactic poly(alkylene oxide) of the present invention are isotactic poly(propylene oxide), isotactic poly(butylene oxide), isotactic poly(pentene oxide), isotactic poly(hexene oxide), isotactic poly(cyclohexene oxide), and isotactic poly(styrene oxide). Among them, preferred is isotactic poly(propylene oxide), isotactic poly(butylene oxide) or isotactic poly(styrene oxide), and more preferred is isotactic poly(propylene oxide) or isotactic poly(butylene oxide).

The isotactic poly(alkylene oxide) of the present invention has number-average molecular weight (Mn) of 500,000 or more, preferably 1,000,000 or more, and more preferably 12,000,000 or more. The number-average molecular weight (Mn) can be regulated by a kind of the after-mentioned aliphatic compound and/or alicyclic compound used in the process of the present invention.

Examples of the epoxide represented by formula (2) are propylene oxide, 1-butene oxide, 1-pentene oxide, 1-hexene oxide, 1-octene oxide, 1-decene oxide, styrene oxide, vinylcyclohexane oxide, 3-phenylpropylene oxide, 3,3,3-trifluoropropylene oxide, 3-naphthylpropylene oxide, 3-phenoxypropylene oxide, and 3-naphthoxypropylene oxide. Among them, preferred is propylene oxide, 1-butene oxide or styrene oxide, and more preferred is propylene oxide or 1-butene oxide.

Examples of the cat used in the process of the present invention are a cobalt complex represented by following formula (3), an aluminum compound, and a zinc compound, and among them, preferred is the cobalt complex represented thereby:

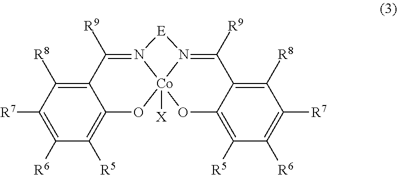

wherein E is a hydrocarbylene group having 1 to 20 carbon atoms; R⁵ to R⁹ are independently of one another a hydrogen atom, a halogen atom, a hydrocarbyl group having 1 to 20 carbon atoms, a hydrocarbylsilyl group having 1 to 20 carbon atoms, a hydrocarbyloxy group having 1 to 20 carbon atoms, a dihydrocarbylamino group having 2 to 20 carbon atoms, an azido group, or a cyano group; and X is a hydroxyl group, a halogen atom, a hydrocarbyloxy group having 1 to 20 carbon atoms, an acyloxy group having 1 to 20 carbon atoms, a dihydrocarbylamino group having 2 to 20 carbon atoms, an azido group, or a cyano group.

Examples of the above aluminum compound are a hydrolyzed product of a trialkylaluminum, a bis(dialkylaluminum)oxide obtained by reacting a dialkylaluminum halide with a dialkylaluminumoxylithium, and an aluminum(porphyrin) complex.

The above hydrolyzed product of a trialkylaluminum can be produced, for example, by a method disclosed in “Macromolecules, Vol. 7, No. 2, pages 153-160, (March, 1974)” edited by American Chemical Society. The hydrolyzed product may be a commercialized product. Examples of the commercialized product are alumoxane products manufactured by TOSOH FINECHEM CORPORATION, such as PMAO-S (trade name) and TMAO-211 (trade name) produced from trimethylaluminum; MMAO-3A (trade name), MMAO-4 (trade name) and TMAO-341 (trade name) produced from a mixture of trimethylaluminum with triisobutylaluminum; and PBAO (trade name) produced from triisobutylaluminum. Also, there can be exemplified a solution (concentration: 30%) of MAO in toluene, and a solution (concentration: 10%) of MAO in toluene, manufactured by Albemarle Corp, wherein MAO means methylaluminoxne.

Examples of the above bis(dialkylaluminum)oxide are bis(dimethylaluminum)oxide, bis(diethylaluminum)oxide, bis(di-n-propylaluminum)oxide, is(diisopropylaluminum)oxide, bis(di-n-butylaluminum)oxide, bis(diisobutylaluminum)oxide, bis(di-sec-butylaluminum)oxide, bis(di-tert-butylaluminum)oxide, bis(diphenylaluminum)oxide, (diethylaluminum)(dimethylaluminum)oxide, (dimethylaluminum)(diisopropylaluminum)oxide, (dimethylaluminum)(diisobutylaluminum)oxide, (diethylaluminum)(diisopropylaluminum)oxide, and (diethylaluminum)(diisobutylaluminum)oxide. These compounds can be produced, for example, by a method disclosed in “Journal of American Chemical Society, Vol. 89, No. 1, pages 173-174, (Jan. 4, 1967)” edited by American Chemical Society.

Examples of the above aluminum(porphyrin) complex are chloro(5,10,15,20-tetramethylporphyrin)aluminum, chloro(5,10,15,20-tetraethylporphyrin)aluminum, chloro(5,10,15,20-tetra-tert-butylporphyrin)aluminum, chloro(5,10,15,20-tetraphenylporphyrin)aluminum, chloro(2,3,7,8,12,13,17,18-octamethylporphyrin)aluminum, chloro(2,3,7,8,12,13,17,18-octaethylporphyrin)aluminum, chloro(2,3,7,8,12,13,17,18-octa-n-propylporphyrin)aluminum, and chloro(2,3,7,8,12,13,17,18-octaisopropylporphyrin)aluminum; and compounds obtained by changing “chloro” in the above compounds to “methyl”, “ethyl”, “isopropyl”, “n-butyl”, “isobutyl”, “n-hexyl”, “n-octyl”, or “phenyl”. These compounds can be produced, for example, by a method disclosed in “Macromolecules, Vol. 27, No. 8, pages 2,013-2,018, (April, 1994)” edited by American Chemical Society.

Examples of the above zinc compound are a hydrolyzed product of an alkylzinc, an alcoholysis reaction product of an alkylzinc, and a bis(alkylzinc)amide.

The above hydrolyzed product of an alkylzinc, and the above alcoholysis reaction product of an alkylzinc can be produced, for example, by a method disclosed in “Polymer, Vol. 3, pages 487-509, (1962)” edited by Elsevier.

Examples of the above bis(alkylzinc)amide are bis(methylzinc)methylamide, bis(methylzinc)ethylamide, bis(methylzinc)-n-propylamide, bis(methylzinc)isopropylamide, bis(methylzinc)-n-butylamide, bis(methylzinc)-tert-butylamide, N,N-bis(methylzinc)aniline, bis(ethylzinc)methylamide, bis(ethylzinc)ethylamide, bis(ethylzinc)-n-propylamide, bis(ethylzinc)isopropylamide, bis(ethylzinc)-n-butylamide, bis(ethylzinc)-tert-butylamide, N,N-bis(ethylzinc)aniline, bis(phenylzinc)methylamide, bis(phenylzinc)ethylamide, bis(phenylzinc)-n-propylamide, bis(phenylzinc)isopropylamide, bis(phenylzinc)-n-butylamide, bis(phenylzinc)-tert-butylamide, and N,N-bis(phenylzinc)aniline. These compounds can be produced, for example, by a method disclosed in “Journal of American Chemical Society, Vol. 89, No. 1, pages 173-174, (Jan. 4, 1967)” edited by American Chemical Society.

Examples of the halogen atom of R⁵, R⁶, R⁷, R⁸, R⁹ and X in formula (3) are a fluorine atom, a chlorine atom, a bromine atom and an iodine atom.

Examples of the hydrocarbyl group having 1 to 20 carbon atoms of R⁵, R⁶, R⁷, R⁸ and R⁹ in formula (3) are an alkyl group having 1 to 20 carbon atoms, an aralkyl group having 7 to 20 carbon atoms, and an aryl group having 6 to 20 carbon atoms. The hydrocarbyl group may have a substitution group. Examples of the substitution group are a halogen atom such as a fluorine atom, a chlorine atom, a bromine atom and an iodine atom; an alkoxy group such as a methoxy group and an ethoxy group; an aryloxy group such as a phenoxy group; and an aralkyloxy group such as a benzyloxy group.

Examples of the above alkyl group having 1 to 20 carbon atoms are a methyl group, an ethyl group, a n-propyl group, an isopropyl group, a n-butyl group, a sec-butyl group, a tert-butyl group, a n-pentyl group, a neopentyl group, a cyclopentyl group, an isoamyl group, a n-hexyl group, a cyclohexyl group, a n-octyl group, a n-decyl group, a n-dodecyl group, a n-pentadecyl group, an eicosyl group, and an adamantyl group. Among them, preferred is a methyl group, an ethyl group, an isopropyl group, a tert-butyl group, a neopentyl group, an isoamyl group, a cyclopentyl group, a cyclohexyl group, or an adamantyl group.

Examples of the alkyl group having 1 to 20 carbon atoms substituted with a halogen atom are a fluoromethyl group, a difluoromethyl group, a trifluoromethyl group, a chloromethyl group, a dichloromethyl group, a trichloromethyl group, a bromomethyl group, a dibromomethyl group, a tribromomethyl group, an iodomethyl group, a diiodomethyl group, a triiodomethyl group, a fluoroethyl group, a difluoroethyl group, a trifluoroethyl group, a tetrafluoroethyl group, a pentafluoroethyl group, a chloroethyl group, a dichloroethyl group, a trichloroethyl group, a tetrachloroethyl group, a pentachloroethyl group, a bromoethyl group, a dibromoethyl group, a tribromoethyl group, a tetrabromoethyl group, a pentabromoethyl group, a perfluoropropyl group, a perfluorobutyl group, a perfluoropentyl group, a perfluorohexyl group, a perfluorooctyl group, a perfluorododecyl group, a perfluoropentadecyl group, a perfluoroeicosyl group, a perchloropropyl group, a perchlorobutyl group, a perchloropentyl group, a perchlorohexyl group, a perchlorooctyl group, a perchlorododecyl group, a perchloropentadecyl group, a perchloroeicosyl group, a perbromopropyl group, a perbromobutyl group, a perbromopentyl group, a perbromohexyl group, a perbromooctyl group, a perbromododecyl group, a perbromopentadecyl group, and a perbromoeicosyl group.

Examples of the above aralkyl group having 7 to 20 carbon atoms are a benzyl group, a (2-methylphenyl)methyl group, a (3-methylphenyl)methyl group, a (4-methylphenyl)methyl group, a (2,3-dimethylphenyl)methyl group, a (2,4-dimethylphenyl)methyl group, a (2,6-dimethylphenyl)methyl group, a (3,4-dimethylphenyl)methyl group, a (3,5-dimethylphenyl)methyl group, a (2,3,4-trimethylphenyl)methyl group, a (2,3,5-trimethylphenyl)methyl group, a (2,3,6-trimethylphenyl)methyl group, a (3,4,5-trimethylphenyl)methyl group, a (2,4,6-trimethylphenyl)methyl group, a (2,3,4,5-tetramethylphenyl)methyl group, a (2,3,4,6-tetramethylphenyl)methyl group, a (2,3,5,6-tetramethylphenyl)methyl group, a (pentamethylphenyl)methyl group, an (ethylphenyl)methyl group, a (n-propylphenyl)methyl group, an (isopropylphenyl)methyl group, a (n-butylphenyl)methyl group, a (sec-butylphenyl)methyl group, a (tert-butylphenyl)methyl group, a (n-pentylphenyl)methyl group, a (neopentylphenyl)methyl group, a (n-hexylphenyl)methyl group, a (n-octylphenyl)methyl group, a (n-decylphenyl)methyl group, a (n-tetradecyphenyl)methyl group, a naphthylmethyl group, and an anthracenylmethyl group. Among them, preferred is a benzyl group.

Examples of the above aryl group having 6 to 20 carbon atoms are a phenyl group, a 2-tolyl group, a 3-tolyl group, a 4-tolyl group, a 2,3-xylyl group, a 2,4-xylyl group, a 2,5-xylyl group, a 2,6-xylyl group, a 3,4-xylyl group, a 3,5-xylyl group, a 2,3,4-trimethylphenyl group, a 2,3,5-trimethylphenyl group, a 2,3,6-trimethylphenyl group, a 2,4,6-trimethylphenyl group, a 3,4,5-trimethylphenyl group, a 2,3,4,5-tetramethylphenyl group, a 2,3,4,6-tetramethylphenyl group, a 2,3,5,6-tetramethylphenyl group, a pentamethylphenyl group, an ethylphenyl group, a n-propylphenyl group, an isopropylphenyl group, a n-butylphenyl group, a sec-butylphenyl group, a tert-butylphenyl group, a n-pentylphenyl group, a neopentylphenyl group, a n-hexylphenyl group, a n-octylphenyl group, a n-decylphenyl group, a n-dodecylphenyl group, a n-tetradecylphenyl group, a naphthyl group, and an anthracenyl group. Among them, preferred is a phenyl group.

The “hydrocarbylsilyl group” of R⁵, R⁶, R⁷, R⁸ and R⁹ means a silyl group whose one, two or three hydrogen atoms are substituted with a hydrocarbyl group. Examples of the hydrocarbyl group are an alkyl group such as a methyl group, an ethyl group, a n-propyl group, an isopropyl group, a n-butyl group, a sec-butyl group, a tert-butyl group, an isobutyl group, a n-pentyl group, a n-hexyl group, and a cyclohexyl group; and an aryl group such as a phenyl group. The hydrocarbyl group may have a substitution group. Examples of the substitution group are a halogen atom such as a fluorine atom, a chlorine atom, a bromine atom and an iodine atom; an alkoxy group such as a methoxy group and an ethoxy group; an aryloxy group such as a phenoxy group; and an aralkyloxy group such as a benzyloxy group.

Examples of the hydrocarbylsilyl group having 1 to 20 carbon atoms are a monohydrocarbylsilyl group having 1 to 20 carbon atoms, a dihydrocarbylsilyl group having 2 to 20 carbon atoms, and a trihydrocarbylsilyl group having 3 to 20 carbon atoms. Examples of the monohydrocarbylsilyl group having 1 to 20 carbon atoms are a methylsilyl group, an ethylsilyl group and a phenylsilyl group. Examples of the dihydrocarbylsilyl group having 2 to 20 carbon atoms are a dimethylsilyl group, a diethylsilyl group and a phenylsilyl group. Examples of the trihydrocarbylsilyl group having 3 to 20 carbon atoms are a trimethylsilyl group, a triethylsilyl group, a tri-n-propylsilyl group, a triisopropylsilyl group, a tri-n-butylsilyl group, a tri-sec-butylsilyl group, a tri-tert-butylsilyl group, a triisobutylsilyl group, a tert-butyl-dimethylsilyl group, a tri-n-pentylsilyl group, a tri-n-hexylsilyl group, a tricyclohexylsilyl group, and a triphenylsilyl group. Among them, preferred is a trimethylsilyl group, a triethylsilyl group, a tert-butyl-dimethylsilyl group, or a triphenylsilyl group.

Examples of the hydrocarbyloxy group having 1 to 20 carbon atoms of R⁵, R⁶, R⁷, R⁸, R⁹ and X are an alkoxy group having 1 to 20 carbon atoms, an aralkyloxy group having 7 to 20 carbon atoms, and an aryloxy group having 6 to 20 carbon atoms. The hydrocarbyloxy group may have a substitution group. Examples of the substitution group are a halogen atom such as a fluorine atom, a chlorine atom, a bromine atom and an iodine atom; an alkoxy group such as a methoxy group and an ethoxy group; an aryloxy group such as a phenoxy group; and an aralkyloxy group such as a benzyloxy group.

Examples of the above alkoxy group having 1 to 20 carbon atoms are a methoxy group, an ethoxy group, a n-propoxy group, an isopropoxy group, a n-butoxy group, a sec-butoxy group, a tert-butoxy group, a n-pentoxy group, a neo-pentoxy group, a n-hexoxy group, a n-octoxy group, a n-dodecoxy group, a n-pentadecoxy group, and an eicosoxy group. Among them, preferred is a methoxy group, an ethoxy group, an isopropoxy group, or a tert-butoxy group.

Examples of the above aralkyloxy group having 7 to 20 carbon atoms are a benzyloxy group, a (2-methylphenyl)methoxy group, a (3-methylphenyl)methoxy group, a (4-methylphenyl)methoxy group, a (2,3-dimethylphenyl)methoxy group, a (2,4-dimethylphenyl)methoxy group, a (2,5-dimethylphenyl)methoxy group, a (2,6-dimethylphenyl)methoxy group, a (3,4-dimethylphenyl)methoxy group, a (3,5-dimethylphenyl)methoxy group, a (2,3,4-trimethylphenyl)methoxy group, a (2,3,5-trimethylphenyl)methoxy group, a (2,4,5-trimethylphenyl)methoxy group, a (2,4,6-trimethylphenyl)methoxy group, a (3,4,5-trimethylphenyl)methoxy group, a (2,3,4,5-tetramethylphenyl)methoxy group, a (2,3,4,6-tetramethylphenyl)methoxy group, a (2,3,5,6-tetramethylphenyl)methoxy group, a (pentamethylphenyl)methoxy group, an (ethylphenyl)methoxy group, a (n-propylphenyl)methoxy group, an (isopropylphenyl)methoxy group, a (n-butylphenyl)methoxy group, a (sec-butylphenyl)methoxy group, a (tert-butylphenyl)methoxy group, a (n-hexylphenyl)methoxy group a (n-octylphenyl)methoxy group, a (n-decylphenyl)methoxy group, a (n-tetradecylphenyl)methoxy group, a naphthylmethoxy group, and an anthracenylmethoxy group. Among them, preferred is a benzyloxy group.

Examples of the above aryloxy group having 6 to 20 carbon atoms are a phenoxy group, a 2-methylphenoxy group, a 3-methylphenoxy group, a 4-methylphenoxy group, a 2,3-dimethylphenoxy group, a 2,4-dimethylphenoxy group, a 2,5-dimethylphenoxy group, a 2,6-dimethylphenoxy group, a 3,4-dimethylphenoxy group, a 3,5-dimethylphenoxy group, a 2,3,4-trimethylphenoxy group, a 2,3,5-trimethylphenoxy a 2,3,6-trimethylphenoxy group, a group, 2,4,5-trimethylphenoxy group, a 2,4,6-trimethylphenoxy group, a 3,4,5-trimethylphenoxy group, a 2,3,4,6-tetramethylphenoxy group, a 2,3,5,6-tetramethylphenoxy group, a pentamethylphenoxy group, an ethylphenoxy group, a n-propylphenoxy group, an isopropylphenoxy group, a n-butylphenoxy group, a sec-butylphenoxy group, a tert-butylphenoxy group, a n-hexylphenoxy group, a n-octylphenoxy group, a n-decylphenoxy group, a n-tetradecylphenoxy group, a naphthoxy group, and an anthracenoxy group.

Examples of the acyloxy group having 1 to 20 carbon atoms of X are an acetoxy group, an ethylcarbonyloxy group, a n-propylcarbonyloxy group, an isopropylcarbonyloxy group, a n-butylcarbonyloxy group, a sec-butylcarbonyloxy group, an isobutylcarbonyloxy group, a tert-butylcarbonyloxy group, a trifluoroacetoxy group, and a benzoyloxy group.

The “dihydrocarbylamino group” of R⁵, R⁶, R⁷, R⁸, R⁹ and X means an amino group whose two hydrogen atoms are substituted with a hydrocarbyl group. Examples of the hydrocarbyl group are an alkyl group such as a methyl group, an ethyl group, a n-propyl group, an isopropyl group, a n-butyl group, a sec-butyl group, a tert-butyl group, an isobutyl group, a n-pentyl group, a n-hexyl group, and a cyclohexyl group; and an aryl group such as a phenyl group.

Examples of the dihydrocarbylamino group having 2 to 20 carbon atoms are a dimethylamino group, a diethylamino group, a di-n-propylamino group, a diisopropylamino group, a di-n-butylamino group, a di-sec-butylamino group, a di-tert-butylamino group, a diisobutylamino group, a tert-butylisopropylamino group, a di-n-hexylamino group, a di-n-octylamino group, a di-n-decylamino group, a diphenylamino group, a bistrimethylsilylamino group, and a bis-tert-butyldimethylsilylamino group. Among them, preferred is a dimethylamino group or a diethylamino group.

The hydrocarbylene group having 1 to 20 carbon atoms of E may have a substitution group. Examples of the substitution group are a halogen atom such as a fluorine atom, a chlorine atom, a bromine atom and an iodine atom; an alkoxy group such as a methoxy group and an ethoxy group; an aryloxy group such as a phenoxy group; and an aralkyloxy group such as a benzyloxy group.

Examples of the hydrocarbylene group having 1 to 20 carbon atoms are an alkylene group having 1 to 20 carbon atoms such as a methylene group, a 1,2-ethanediyl group, and a 1,3-propanediyl group; a cycloalkylene group having 3 to 20 carbon atoms such as a 1,2-cyclopentanediyl group, a 1,3-cyclopentanediyl group, a 1,2-cyclohexanediyl group, a 1,3-cyclohexanediyl group, a 1,4-cyclohexanediyl group, and a 1,2-norbornanediyl group; and an arylene group such as a 1,2-benzenediyl group, a 1,3-benzenediyl group, a 1,4-benzenediyl group, a 2,3-naphthalenediyl group, and a 1,8-naphthalenediyl group. Among them, preferred is a 1,2-ethanediyl group, a 1,2-cyclohexanediyl group, a 1,2-benzenediyl group, a 2,3-naphthalenediyl group, or a 1,8-naphthalenediyl group, and more preferred is a 1,2-cyclohexanediyl group or a 1,2-benzenediyl group.

R⁵ in formula (3) is preferably a branched or cyclic alkyl group having 3 to 20 carbon atoms, and more preferably an isopropyl group, a tert-butyl group, a neopentyl group, an isoamyl group, a cyclopentyl group, a cyclohexl group, or an adamantyl group.

Examples of the cobalt complex represented by formula (3) are as follows: [N,N′-bis(salicylidene)methanediamine]cobalt acetate, [N,N′-bis(salicylidene)-1,2-ethanediamine]cobalt acetate, [N,N′-bis(salicylidene)-1,3-propanediamine]cobalt acetate, [N,N′-bis(salicylidene)-1,2-cyclopentanediamine]cobalt acetate, [N,N′-bis(salicylidene)-1,3-cyclopentanediamine]cobalt acetate, [N,N′-bis(salicylidene)-1,2-cyclohexanediamine]cobalt acetate, [N,N′-bis(salicylidene)-1,3-cyclohexanediamine]cobalt acetate, [N,N′-bis(salicylidene)-1,4-cyclohexanediamine]cobalt acetate, [N,N′-bis(salicylidene)-1,2-norbornanediamine]cobalt acetate, [N,N′-bis(salicylidene)-1,2-benzenediamine]cobalt acetate, [N,N′-bis(salicylidene)-1,3-benzenediamine]cobalt acetate, [N,N′-bis(salicylidene)-1,4-benzenediamine]cobalt acetate, [N,N′-bis(salicylidene)-4-methoxy-1,2-benzenediamine]cobalt acetate, [N,N′-bis(salicylidene)-2,3-naphthalenediamine]cobalt acetate, [N,N′-bis(salicylidene)-1,8-acetate, naphthalenediamine]cobalt acetate, [N,N′-bis(5-methylsalicylidene)methanediamine]cobalt acetate, [N,N′-bis(5-methylsalicylidene)-1,2-ethanediamine]cobalt acetate, [N,N′-bis(5-methylsalicylidene)-1,3-propanediamine]cobalt acetate, [N,N′-bis(5-methylsalicylidene)-1,2-cyclopentanediamine]cobalt acetate, [N,N′-bis(5-methylsalicylidene)-1,3-cyclopentanediamine]cobalt acetate, [N,N′-bis(5-methylsalicylidene)-1,2-cyclohexanediamine]cobalt acetate, [N,N′-bis(5-methylsalicylidene)-1,3-cyclohexanediamine]cobalt acetate, [N,N′-bis(5-methylsalicylidene)-1,4-cyclohexanediamine]cobalt acetate, [N,N′-bis(5-methylsalicylidene)-1,2-norbornanediamine]cobalt acetate, [N,N′-bis(5-methylsalicylidene)-1,2-benzenediamine]cobalt acetate, [N,N′-bis(5-methylsalicylidene)-1,3-benzenediamine]cobalt acetate, [N,N′-bis(5-methylsalicylidene)-1,4-benzenediamine]cobalt acetate, [N,N′-bis(5-methylsalicylidene)-4-methoxy-1,2-benzene diamine]cobalt acetate, [N,N′-bis(5-methylsalicylidene)-2,3-naphthalenediamine]cobalt acetate, [N,N′-bis(5-methylsalicylidene)-1,8-naphthalenediamine]cobalt acetate, [N,N′-bis(5-ethylsalicylidene)methanediamine]cobalt acetate, [N,N′-bis(5-ethylsalicylidene)-1,2-ethanediamine]cobalt acetate, [N,N′-bis(5-ethylsalicylidene)-1,3-propanediamine]cobalt acetate, [N,N′-bis(5-ethylsalicylidene)-1,2-cyclopentanediamine]cobalt acetate, [N,N′-bis(5-ethylsalicylidene)-1,3-cyclopentanediamine]cobalt acetate, [N,N′-bis(5-ethylsalicylidene)-1,2-cyclohexanediamine]cobalt acetate, [N,N′-bis(5-ethylsalicylidene)-1,3-cyclohexanediamine]cobalt acetate, [N,N′-bis(5-ethylsalicylidene)-1,4-cyclohexanediamine]cobalt acetate, [N,N′-bis(5-ethylsalicylidene)-1,2-norbornanediamine]cobalt acetate, [N,N′-bis(5-ethylsalicylidene)-1,2-benzenediamine]cobalt acetate, [N,N′-bis(5-ethylsalicylidene)-1,3-benzenediamine]cobalt acetate, [N,N′-bis(5-ethylsalicylidene)-1,4-benzenediamine]cobalt acetate, [N,N′-bis(5-ethylsalicylidene)-4-methoxy-1,2-benzene diamine]cobalt acetate, [N,N′-bis(5-ethylsalicylidene)-2,3-naphthalenediamine]cobalt acetate, [N,N′-bis(5-ethylsalicylidene)-1,8-naphthalenediamine]cobalt acetate, [N,N′-bis(5-n-propylsalicylidene)methanediamine]cobalt acetate, [N,N′-bis(5-n-propylsalicylidene)-1,2-ethanediamine]cobalt acetate, [N,N′-bis(5-n-propylsalicylidene)-1,3-propanediamine]cobalt acetate, [N,N′-bis(5-n-propylsalicylidene)-1,2-cyclopentanediamine]cobalt acetate, [N,N′-bis(5-n-propylsalicylidene)-1,3-cyclopentanediamine]cobalt acetate, [N,N′-bis(5-n-propylsalicylidene)-1,2-cyclohexanediamine]cobalt acetate, [N,N′-bis(5-n-propylsalicylidene)-1,3-cyclohexanediamine]cobalt acetate, [N,N′-bis(5-n-propylsalicylidene)-1,4-cyclohexanediamine]cobalt acetate, [N,N′-bis(5-n-propylsalicylidene)-1,2-norbornanediamine]cobalt acetate, [N,N′-bis(5-n-propylsalicylidene)-1,2-benzenediamine]cobalt acetate, [N,N′-bis(5-n-propylsalicylidene)-1,3-benzenediamine]cobalt acetate, [N,N′-bis(5-n-propylsalicylidene)-1,4-benzenediamine]cobalt acetate, [N,N′-bis(5-n-propylsalicylidene)-4-methoxy-1,2-benzene diamine]cobalt acetate, [N,N′-bis(5-n-propylsalicylidene)-2,3-naphthalenediamine]cobalt acetate, [N,N′-bis(5-n-propylsalicylidene)-1,8-naphthalenediamine]cobalt acetate, [N,N′-bis(5-isopropylsalicylidene)methanediamine]cobalt acetate, [N,N′-bis(5-isopropylsalicylidene)-1,2-ethanediamine]cobalt acetate, [N,N′-bis(5-isopropylsalicylidene)-1,3-propanediamine]cobalt acetate, [N,N′-bis(5-isopropylsalicylidene)-1,2-cyclopentanediamine]cobalt acetate, [N,N′-bis(5-isopropylsalicylidene)-1,3-cyclopentanediamine]cobalt acetate, [N,N′-bis(5-isopropylsalicylidene)-1,2-cyclohexanediamine]cobalt acetate, [N,N′-bis(5-isopropylsalicylidene)-1,3-cyclohexanediamine]cobalt acetate, [N,N′-bis(5-isopropylsalicylidene)-1,4-cyclohexanediamine]cobalt acetate, [N,N′-bis(5-isopropylsalicylidene)-1,2-norbornanediamine]cobalt acetate, [N,N′-bis(5-isopropylsalicylidene)-1,2-benzenediamine]cobalt acetate, [N,N′-bis(5-isopropylsalicylidene)-1,3-benzenediamine]cobalt acetate, [N,N′-bis(5-isopropylsalicylidene)-1,4-benzenediamine]cobalt acetate, [N,N′-bis(5-isopropylsalicylidene)-4-methoxy-1,2-benzenedi amine]cobalt acetate, [N,N′-bis(5-isopropylsalicylidene)-2,3-naphthalenediamine]cobalt acetate, [N,N′-bis(5-isopropylsalicylidene)-1,8-naphthalenediamine]cobalt acetate, [N,N′-bis(5-n-butylsalicylidene)methanediamine]cobalt acetate, [N,N′-bis(5-n-butylsalicylidene)-1,2-ethanediamine]cobalt acetate, [N,N′-bis(5-n-butylsalicylidene)-1,3-propanediamine]cobalt acetate, [N,N′-bis(5-n-butylsalicylidene)-1,2-cyclopentanediamine]cobalt acetate, [N,N′-bis(5-n-butylsalicylidene)-1,3-cyclopentanediamine]cobalt acetate, [N,N′-bis(5-n-butylsalicylidene)-1,2-cyclohexanediamine]cobalt acetate, [N,N′-bis(5-n-butylsalicylidene)-1,3-cyclohexanediamine]cobalt acetate, [N,N′-bis(5-n-butylsalicylidene)-1,4-cyclohexanediamine]cobalt acetate, [N,N′-bis(5-n-butylsalicylidene)-1,2-norbornanediamine]cobalt acetate, [N,N′-bis(5-n-butylsalicylidene)-1,2-benzenediamine]cobalt acetate, [N,N′-bis(5-n-butylsalicylidene)-1,3-benzenediamine]cobalt acetate, [N,N′-bis(5-n-butylsalicylidene)-1,4-benzenediamine]cobalt acetate, [N,N′-bis(5-n-butylsalicylidene)-4-methoxy-1,2-benzene diamine]cobalt acetate, [N,N′-bis(5-n-butylsalicylidene)-2,3-naphthalenediamine]cobalt acetate, [N,N′-bis(5-n-butylsalicylidene)-1,8-naphthalenediamine]cobalt acetate, [N,N′-bis(5-isobutylsalicylidene)methanediamine]cobalt acetate, [N,N′-bis(5-isobutylsalicylidene)-1,2-ethanediamine]cobalt acetate, [N,N′-bis(5-isobutylsalicylidene)-1,3-propanediamine]cobalt acetate, [N,N′-bis(5-isobutylsalicylidene)-1,2-cyclopentanediamine]cobalt acetate, [N,N′-bis(5-isobutylsalicylidene)-1,3-cyclopentanediamine]cobalt acetate, [N,N′-bis(5-isobutylsalicylidene)-1,2-cyclohexanediamine]cobalt acetate, [N,N′-bis(5-isobutylsalicylidene)-1,3-cyclohexanediamine]cobalt acetate, [N,N′-bis(5-isobutylsalicylidene)-1,4-cyclohexanediamine]cobalt acetate, [N,N′-bis(5-isobutylsalicylidene)-1,2-norbornanediamine]cobalt acetate, [N,N′-bis(5-isobutylsalicylidene)-1,2-benzenediamine]cobalt acetate, [N,N′-bis(5-isobutylsalicylidene)-1,3-benzenediamine]cobalt acetate, [N,N′-bis(5-isobutylsalicylidene)-1,4-benzenediamine]cobalt acetate, [N,N′-bis(5-isobutylsalicylidene)-4-methoxy-1,2-benzene diamine]cobalt acetate, [N,N′-bis(5-isobutylsalicylidene)-2,3-naphthalenediamine]cobalt acetate, [N,N′-bis(5-isobutylsalicylidene)-1,8-naphthalenediamine]cobalt acetate, [N,N′-bis(5-sec-butylsalicylidene)methanediamine]cobalt acetate, [N,N′-bis(5-sec-butylsalicylidene)-1,2-ethanediamine]cobalt acetate, [N,N′-bis(5-sec-butylsalicylidene)-1,3-propanediamine]cobalt acetate, [N,N′-bis(5-sec-butylsalicylidene)-1,2-cyclopentanediamine]cobalt acetate, [N,N′-bis(5-sec-butylsalicylidene)-1,3-cyclopentanediamine]cobalt acetate, [N,N′-bis(5-sec-butylsalicylidene)-1,2-cyclohexanediamine]cobalt acetate, [N,N′-bis(5-sec-butylsalicylidene)-1,3-cyclohexanediamine]cobalt acetate, [N,N′-bis(5-sec-butylsalicylidene)-1,4-cyclohexanediamine]cobalt acetate, [N,N′-bis(5-sec-butylsalicylidene)-1,2-norbornanediamine]cobalt acetate, [N,N′-bis(5-sec-butylsalicylidene)-1,2-benzenediamine]cobalt acetate, [N,N′-bis(5-sec-butylsalicylidene)-1,3-benzenediamine]cobalt acetate, [N,N′-bis(5-sec-butylsalicylidene)-1,4-benzenediamine]cobalt acetate, [N,N′-bis(5-sec-butylsalicylidene)-4-methoxy-1,2-benzene diamine]cobalt acetate, [N,N′-bis(5-sec-butylsalicylidene)-2,3-naphthalenediamine]cobalt acetate, [N,N′-bis(5-sec-butylsalicylidene)-1,8-naphthalenediamine]cobalt acetate, [N,N′-bis(5-tert-butylsalicylidene)methanediamine]cobalt acetate, [N,N′-bis(5-tert-butylsalicylidene)-1,2-ethanediamine]cobalt acetate, [N,N′-bis(5-tert-butylsalicylidene)-1,3-propanediamine]cobalt acetate, [N,N′-bis(5-tert-butylsalicylidene)-1,2-cyclopentanediamine]cobalt acetate, [N,N′-bis(5-tert-butylsalicylidene)-1,3-cyclopentane diamine]cobalt acetate, [N,N′-bis(5-tert-butylsalicylidene)-1,2-cyclohexanediamine]cobalt acetate, [N,N′-bis(5-tert-butylsalicylidene)-1,3-cyclohexanediamine]cobalt acetate, [N,N′-bis(5-tert-butylsalicylidene)-1,4-cyclohexanediamine]cobalt acetate, [N,N′-bis(5-tert-butylsalicylidene)-1,2-norbornanediamine]cobalt acetate, [N,N′-bis(5-tert-butylsalicylidene)-1,2-benzenediamine]cobalt acetate, [N,N′-bis(5-tert-butylsalicylidene)-1,3-benzenediamine]cobalt acetate, [N,N′-bis(5-tert-butylsalicylidene)-1,4-benzenediamine]cobalt acetate, [N,N′-bis(5-tert-butylsalicylidene)-4-methoxy-1,2-benzene diamine]cobalt acetate, [N,N′-bis(5-tert-butylsalicylidene)-2,3-naphthalenediamine]cobalt acetate, [N,N′-bis(5-tert-butylsalicylidene)-1,8-naphthalenediamine]cobalt acetate, [N,N′-bis(5-neopentylsalicylidene)methanediamine]cobalt acetate, [N,N′-bis(5-neopentylsalicylidene)-1,2-ethanediamine]cobalt acetate, [N,N′-bis(5-neopentylsalicylidene)-1,3-propanediamine]cobalt acetate, [N,N′-bis(5-neopentylsalicylidene)-1,2-cyclopentanediamine]cobalt acetate, [N,N′-bis(5-neopentylsalicylidene)-1,3-cyclopentanediamine]cobalt acetate, [N,N′-bis(5-neopentylsalicylidene)-1,2-cyclohexanediamine]cobalt acetate, [N,N′-bis(5-neopentylsalicylidene)-1,3-cyclohexanediamine]cobalt acetate, [N,N′-bis(5-neopentylsalicylidene)-1,4-cyclohexanediamine]cobalt acetate, [N,N′-bis(5-neopentylsalicylidene)-1,2-norbornanediamine]cobalt acetate, [N,N′-bis(5-neopentylsalicylidene)-1,2-benzenediamine]cobalt acetate, [N,N′-bis(5-neopentylsalicylidene)-1,3-benzenediamine]cobalt acetate, [N,N′-bis(5-neopentylsalicylidene)-1,4-benzenediamine]cobalt acetate, [N,N′-bis(5-neopentylsalicylidene)-4-methoxy-1,2-benzene diamine]cobalt acetate, [N,N′-bis(5-neopentylsalicylidene)-2,3-naphthalenediamine]cobalt acetate, [N,N′-bis(5-neopentylsalicylidene)-1,8-naphthalenediamine]cobalt acetate, [N,N′-bis(5-isoamylsalicylidene)methanediamine]cobalt acetate, [N,N′-bis(5-isoamylsalicylidene)-1,2-ethanediamine]cobalt acetate, [N,N′-bis(5-isoamylsalicylidene)-1,3-propanediamine]cobalt acetate, [N,N′-bis(5-isoamylsalicylidene)-1,2-cyclopentanediamine]cobalt acetate, [N,N′-bis(5-isoamylsalicylidene)-1,3-cyclopentanediamine]cobalt acetate, [N,N′-bis(5-isoamylsalicylidene)-1,2-cyclohexanediamine]cobalt acetate, [N,N′-bis(5-isoamylsalicylidene)-1,3-cyclohexanediamine]cobalt acetate, [N,N′-bis(5-isoamylsalicylidene)-1,4-cyclohexanediamine]cobalt acetate, [N,N′-bis(5-isoamylsalicylidene)-1,2-norbornanediamine]cobalt acetate, [N,N′-bis(5-isoamylsalicylidene)-1,2-benzenediamine]cobalt acetate, [N,N′-bis(5-isoamylsalicylidene)-1,3-benzenediamine]cobalt acetate, [N,N′-bis(5-isoamylsalicylidene)-1,4-benzenediamine]cobalt acetate, [N,N′-bis(5-isoamylsalicylidene)-4-methoxy-1,2-benzene diamine]cobalt acetate, [N,N′-bis(5-isoamylsalicylidene)-2,3-naphthalenediamine]cobalt acetate, [N,N′-bis(5-isoamylsalicylidene)-1,8-naphthalenediamine]cobalt acetate, [N,N′-bis(5-phenylsalicylidene)methanediamine]cobalt acetate, [N,N′-bis(5-phenylsalicylidene)-1,2-ethanediamine]cobalt acetate, [N,N′-bis(5-phenylsalicylidene)-1,3-propanediamine]cobalt acetate, [N,N′-bis(5-phenylsalicylidene)-1,2-cyclopentanediamine]cobalt acetate, [N,N′-bis(5-phenylsalicylidene)-1,3-cyclopentanediamine]cobalt acetate, [N,N′-bis(5-phenylsalicylidene)-1,2-cyclohexanediamine]cobalt acetate, [N,N′-bis(5-phenylsalicylidene)-1,3-cyclohexanediamine]cobalt acetate, [N,N′-bis(5-phenylsalicylidene)-1,4-cyclohexanediamine]cobalt acetate, [N,N′-bis(5-phenylsalicylidene)-1,2-norbornanediamine]cobalt acetate, [N,N′-bis(5-phenylsalicylidene)-1,2-benzenediamine]cobalt acetate, [N,N′-bis(5-phenylsalicylidene)-1,3-benzenediamine]cobalt acetate, [N,N′-bis(5-phenylsalicylidene)-1,4-benzenediamine]cobalt acetate, [N,N′-bis(5-phenylsalicylidene)-4-methoxy-1,2-benzene diamine]cobalt acetate, [N,N′-bis(5-phenylsalicylidene)-2,3-naphthalenediamine]cobalt acetate, [N,N′-bis(5-phenylsalicylidene)-1,8-naphthalenediamine]cobalt acetate, [N,N′-bis(5-trifluoromethylsalicylidene)methanediamine]cobalt acetate, [N,N′-bis(5-trifluoromethylsalicylidene)-1,2-ethanediamine]cobalt acetate, [N,N′-bis(5-trifluoromethylsalicylidene)-1,3-propane diamine]cobalt acetate, [N,N′-bis(5-trifluoromethylsalicylidene)-1,2-cyclopentane diamine]cobalt acetate, [N,N′-bis(5-trifluoromethylsalicylidene)-1,3-cyclopentane diamine]cobalt acetate, [N,N′-bis(5-trifluoromethylsalicylidene)-1,2-cyclohexane diamine]cobalt acetate, [N,N′-bis(5-trifluoromethylsalicylidene)-1,3-cyclohexane diamine]cobalt acetate, [N,N′-bis(5-trifluoromethylsalicylidene)-1,4-cyclohexane diamine]cobalt acetate, [N,N′-bis(5-trifluoromethylsalicylidene)-1,2-norbornane diamine]cobalt acetate, [N,N′-bis(5-trifluoromethylsalicylidene)-1,2-benzene diamine]cobalt acetate, [N,N′-bis(5-trifluoromethylsalicylidene)-1,3-benzene diamine]cobalt acetate, [N,N′-bis(5-trifluoromethylsalicylidene)-1,4-benzene diamine]cobalt acetate, [N,N′-bis(5-trifluoromethylsalicylidene)-4-methoxy-1,2-benzenediamine]cobalt acetate, [N,N′-bis(5-trifluoromethylsalicylidene)-2,3-naphthalene diamine]cobalt acetate, [N,N′-bis(5-trifluoromethylsalicylidene)-1,8-naphthalenediamine]cobalt acetate, [N,N′-bis(5-trimethylsiylsalicylidene)methanediamine]cobalt acetate, [N,N′-bis(5-trimethylsiylsalicylidene)-1,2-ethanediamine]cobalt acetate, [N,N′-bis(5-trimethylsiylsalicylidene)-1,3-propanediamine]cobalt acetate, [N,N′-bis(5-trimethylsiylsalicylidene)-1,2-cyclopentane diamine]cobalt acetate, [N,N′-bis(5-trimethylsiylsalicylidene)-1,3-cyclopentane diamine]cobalt acetate, [N,N′-bis(5-trimethylsiylsalicylidene)-1,2-cyclohexane diamine]cobalt acetate, [N,N′-bis(5-trimethylsiylsalicylidene)-1,3-cyclohexane diamine]cobalt acetate, [N,N′-bis(5-trimethylsiylsalicylidene)-1,4-cyclohexane diamine]cobalt acetate, [N,N′-bis(5-trimethylsiylsalicylidene)-1,2-norbornane diamine]cobalt acetate, [N,N′-bis(5-trimethylsiylsalicylidene)-1,2-benzenediamine]cobalt acetate, [N,N′-bis(5-trimethylsiylsalicylidene)-1,3-benzenediamine]cobalt acetate, [N,N′-bis(5-trimethylsiylsalicylidene)-1,4-benzenediamine]cobalt acetate, [N,N′-bis(5-trimethylsiylsalicylidene)-4-methoxy-1,2-benzenediamine]cobalt acetate, [N,N′-bis(5-trimethylsiylsalicylidene)-2,3-naphthalene diamine]cobalt acetate, [N,N′-bis(5-trimethylsiylsalicylidene)-1,8-naphthalenediamine]cobalt acetate, and compounds obtained by changing the term “acetate” contained in the above compounds to the term “propionate”, “n-butyrate”, “isobutyrate”, “n-pentyrate”, “isopentyrate”, “sec-pentyrate”, “tert-pentyrate”, “trifluoroacetate”, “benzoate”, “fluoride”, “chloride”, “bromide”, “iodide”, “methoxide”, “ethoxide”, “pentafluorophenoxide”, “benzyloxide”, “dimethylamide”, “diethylamide”, “hydroxide”, or “cyanide”.

Also, examples of the cobalt complex represented by formula (3) are as follows: [N,N′-bis(5-ethyl-3-methylsalicylidene)methanediamine]cobalt acetate, [N,N′-bis(5-ethyl-3-methylsalicylidene)-1,2-ethanediamine]cobalt acetate, [N,N′-bis(5-ethyl-3-methylsalicylidene)-1,3-propanediamine]cobalt acetate, [N,N′-bis(5-ethyl-3-methylsalicylidene)-1,2-cyclopentane diamine]cobalt acetate, [N,N′-bis(5-ethyl-3-methylsalicylidene)-1,3-cyclopentane diamine]cobalt acetate, [N,N′-bis(5-ethyl-3-methylsalicylidene)-1,2-cyclohexane diamine]cobalt acetate, [N,N′-bis(5-ethyl-3-methylsalicylidene)-1,3-cyclohexane diamine]cobalt acetate, [N,N′-bis(5-ethyl-3-methylsalicylidene)-1,4-cyclohexane diamine]cobalt acetate, [N,N′-bis(5-ethyl-3-methylsalicylidene)-1,2-norbornane diamine]cobalt acetate, [N,N′-bis(5-ethyl-3-methylsalicylidene)-1,2-benzenediamine]cobalt acetate, [N,N′-bis(5-ethyl-3-methylsalicylidene)-1,3-benzenediamine]cobalt acetate, [N,N′-bis(5-ethyl-3-methylsalicylidene)-1,4-benzenediamine]cobalt acetate, [N,N′-bis(5-ethyl-3-methylsalicylidene)-4-methoxy-1,2-benzenediamine]cobalt acetate, [N,N′-bis(5-ethyl-3-methylsalicylidene)-2,3-naphthalene diamine]cobalt acetate, [N,N′-bis(5-ethyl-3-methylsalicylidene)-1,8-naphthalenediamine]cobalt acetate, [N,N′-bis(3-methyl-5-n-propylsalicylidene)methanediamine]cobalt acetate, [N,N′-bis(3-methyl-5-n-propylsalicylidene)-1,2-ethane diamine]cobalt acetate, [N,N′-bis(3-methyl-5-n-propylsalicylidene)-1,3-propane diamine]cobalt acetate, [N,N′-bis(3-methyl-5-n-propylsalicylidene)-1,2-cyclopentane diamine]cobalt acetate, [N,N′-bis(3-methyl-5-n-propylsalicylidene)-1,3-cyclopentane diamine]cobalt acetate, [N,N′-bis(3-methyl-5-n-propylsalicylidene)-1,2-cyclohexane diamine]cobalt acetate, [N,N′-bis(3-methyl-5-n-propylsalicylidene)-1,3-cyclohexane diamine]cobalt acetate, [N,N′-bis(3-methyl-5-n-propylsalicylidene)-1,4-cyclohexanediamine]cobalt acetate, [N,N′-bis(3-methyl-5-n-propylsalicylidene)-1,2-norbornane diamine]cobalt acetate, [N,N′-bis(3-methyl-5-n-propylsalicylidene)-1,2-benzene diamine]cobalt acetate, [N,N′-bis(3-methyl-5-n-propylsalicylidene)-1,3-benzene diamine]cobalt acetate, [N,N′-bis(3-methyl-5-n-propylsalicylidene)-1,4-benzene diamine]cobalt acetate, [N,N′-bis(3-methyl-5-n-propylsalicylidene)-4-methoxy-1,2-benzenediamine]cobalt acetate, [N,N′-bis(3-methyl-5-n-propylsalicylidene)-2,3-naphthalene diamine]cobalt acetate, [N,N′-bis(3-methyl-5-n-propylsalicylidene)-1,8-naphthalenediamine]cobalt acetate, [N,N′-bis(3-methyl-5-isopropylsalicylidene)methanediamine]cobalt acetate, [N,N′-bis(3-methyl-5-isopropylsalicylidene)-1,2-ethane diamine]cobalt acetate, [N,N′-bis(3-methyl-5-isopropylsalicylidene)-1,3-propane diamine]cobalt acetate, [N,N′-bis(3-methyl-5-isopropylsalicylidene)-1,2-cyclopentanediamine]cobalt acetate, [N,N′-bis(3-methyl-5-isopropylsalicylidene)-1,3-cyclopentanediamine]cobalt acetate, [N,N′-bis(3-methyl-5-isopropylsalicylidene)-1,2-cyclohexane diamine]cobalt acetate, [N,N′-bis(3-methyl-5-isopropylsalicylidene)-1,3-cyclohexane diamine]cobalt acetate, [N,N′-bis(3-methyl-5-isopropylsalicylidene)-1,4-cyclohexane diamine]cobalt acetate, [N,N′-bis(3-methyl-5-isopropylsalicylidene)-1,2-norbornane diamine]cobalt acetate, [N,N′-bis(3-methyl-5-isopropylsalicylidene)-1,2-benzene diamine]cobalt acetate, [N,N′-bis(3-methyl-5-isopropylsalicylidene)-1,3-benzene diamine]cobalt acetate, [N,N′-bis(3-methyl-5-isopropylsalicylidene)-1,4-benzene acetate, diamine]cobalt acetate, [N,N′-bis(3-methyl-5-isopropylsalicylidene)-4-methoxy-1,2-benzenediamine]cobalt acetate, [N,N′-bis(3-methyl-5-isopropylsalicylidene)-2,3-naphthalene diamine]cobalt acetate, [N,N′-bis(3-methyl-5-isopropylsalicylidene)-1,8-naphthalenediamine]cobalt acetate, [N,N′-bis(5-n-butyl-3-methylsalicylidene)methanediamine]cobalt acetate, [N,N′-bis(5-n-butyl-3-methylsalicylidene)-1,2-ethane acetate, diamine]cobalt [N,N′-bis(5-n-butyl-3-methylsalicylidene)-1,3-propane diamine]cobalt acetate, [N,N′-bis(5-n-butyl-3-methylsalicylidene)-1,2-cyclopentane diamine]cobalt acetate, [N,N′-bis(5-n-butyl-3-methylsalicylidene)-1,3-cyclopentane diamine]cobalt acetate, [N,N′-bis(5-n-butyl-3-methylsalicylidene)-1,2-cyclohexane diamine]cobalt acetate, [N,N′-bis(5-n-butyl-3-methylsalicylidene)-1,3-cyclohexane diamine]cobalt acetate, [N,N′-bis(5-n-butyl-3-methylsalicylidene)-1,4-cyclohexane diamine]cobalt acetate, [N,N′-bis(5-n-butyl-3-methylsalicylidene)-1,2-norbornane diamine]cobalt acetate, [N,N′-bis(5-n-butyl-3-methylsalicylidene)-1,2-benzene diamine]cobalt acetate, [N,N′-bis(5-n-butyl-3-methylsalicylidene)-1,3-benzene diamine]cobalt acetate, [N,N′-bis(5-n-butyl-3-methylsalicylidene)-1,4-benzene diamine]cobalt acetate, [N,N′-bis(5-n-butyl-3-methylsalicylidene)-4-methoxy-1,2-benzenediamine]cobalt acetate, [N,N′-bis(5-n-butyl-3-methylsalicylidene)-2,3-naphthalene diamine]cobalt acetate, [N,N′-bis(5-n-butyl-3-methylsalicylidene)-1,8-naphthalenediamine]cobalt acetate, [N,N′-bis(5-isobutyl-3-methylsalicylidene)methanediamine]cobalt acetate, [N,N′-bis(5-isobutyl-3-methylsalicylidene)-1,2-ethane diamine]cobalt acetate, [N,N′-bis(5-isobutyl-3-methylsalicylidene)-1,3-propane diamine]cobalt acetate, [N,N′-bis(5-isobutyl-3-methylsalicylidene)-1,2-cyclopentane diamine]cobalt acetate, [N,N′-bis(5-isobutyl-3-methylsalicylidene)-1,3-cyclopentane diamine]cobalt acetate, [N,N′-bis(5-isobutyl-3-methylsalicylidene)-1,2-cyclohexane diamine]cobalt acetate, [N,N′-bis(5-isobutyl-3-methylsalicylidene)-1,3-cyclohexane diamine]cobalt acetate, [N,N′-bis(5-isobutyl-3-methylsalicylidene)-1,4-cyclohexane diamine]cobalt acetate, [N,N′-bis(5-isobutyl-3-methylsalicylidene)-1,2-norbornane diamine]cobalt acetate, [N,N′-bis(5-isobutyl-3-methylsalicylidene)-1,2-benzene diamine]cobalt acetate, [N,N′-bis(5-isobutyl-3-methylsalicylidene)-1,3-benzene diamine]cobalt acetate, [N,N′-bis(5-isobutyl-3-methylsalicylidene)-1,4-benzene diamine]cobalt acetate, [N,N′-bis(5-isobutyl-3-methylsalicylidene)-4-methoxy-1,2-benzenediamine]cobalt acetate, [N,N′-bis(5-isobutyl-3-methylsalicylidene)-2,3-naphthalene diamine]cobalt acetate, [N,N′-bis(5-isobutyl-3-methylsalicylidene)-1,8-naphthalenediamine]cobalt acetate, [N,N′-bis(5-sec-butyl-3-methylsalicylidene)methanediamine]cobalt acetate, [N,N′-bis(5-sec-butyl-3-methylsalicylidene)-1,2-ethane diamine]cobalt acetate, [N,N′-bis(5-sec-butyl-3-methylsalicylidene)-1,3-propane diamine]cobalt acetate, [N,N′-bis(5-sec-butyl-3-methylsalicylidene)-1,2-cyclopentanediamine]cobalt acetate, [N,N′-bis(5-sec-butyl-3-methylsalicylidene)-1,3-cyclopentanediamine]cobalt acetate, [N,N′-bis(5-sec-butyl-3-methylsalicylidene)-1,2-cyclohexane diamine]cobalt acetate, [N,N′-bis(5-sec-butyl-3-methylsalicylidene)-1,3-cyclohexane diamine]cobalt acetate, [N,N′-bis(5-sec-butyl-3-methylsalicylidene)-1,4-cyclohexane diamine]cobalt acetate, [N,N′-bis(5-sec-butyl-3-methylsalicylidene)-1,2-norbornanediamine]cobalt acetate, [N,N′-bis(5-sec-butyl-3-methylsalicylidene)-1,2-benzene diamine]cobalt acetate, [N,N′-bis(5-sec-butyl-3-methylsalicylidene)-1,3-benzene diamine]cobalt acetate, [N,N′-bis(5-sec-butyl-3-methylsalicylidene)-1,4-benzene diamine]cobalt acetate, [N,N′-bis(5-sec-butyl-3-methylsalicylidene)-4-methoxy-1,2-benzenediamine]cobalt acetate, [N,N′-bis(5-sec-butyl-3-methylsalicylidene)-2,3-naphthalene diamine]cobalt acetate, [N,N′-bis(5-sec-butyl-3-methylsalicylidene)-1,8-naphthalenediamine]cobalt acetate, [N,N′-bis(5-tert-butyl-3-methylsalicylidene)methanediamine]cobalt acetate, [N,N′-bis(5-tert-butyl-3-methylsalicylidene)-1,2-ethane diamine]cobalt acetate, [N,N′-bis(5-tert-butyl-3-methylsalicylidene)-1,3-propane diamine]cobalt acetate, [N,N′-bis(5-tert-butyl-3-methylsalicylidene)-1,2-cyclopentanediamine]cobalt acetate, [N,N′-bis(5-tert-butyl-3-methylsalicylidene)-1,3-cyclopentanediamine]cobalt acetate, [N,N′-bis(5-tert-butyl-3-methylsalicylidene)-1,2-cyclohexanediamine]cobalt acetate, [N,N′-bis(5-tert-butyl-3-methylsalicylidene)-1,3-cyclohexanediamine]cobalt acetate, [N,N′-bis(5-tert-butyl-3-methylsalicylidene)-1,4-cyclohexanediamine]cobalt acetate, [N,N′-bis(5-tert-butyl-3-methylsalicylidene)-1,2-norbornane diamine]cobalt acetate, [N,N′-bis(5-tert-butyl-3-methylsalicylidene)-1,2-benzene diamine]cobalt acetate, [N,N′-bis(5-tert-butyl-3-methylsalicylidene)-1,3-benzene diamine]cobalt acetate, [N,N′-bis(5-tert-butyl-3-methylsalicylidene)-1,4-benzene diamine]cobalt acetate, [N,N′-bis(5-tert-butyl-3-methylsalicylidene)-4-methoxy-1,2-benzenediamine]cobalt acetate, [N,N′-bis(5-tert-butyl-3-methylsalicylidene)-2,3-naphthalenediamine]cobalt acetate, [N,N′-bis(5-tert-butyl-3-methylsalicylidene)-1,8-naphthalenediamine]cobalt acetate, [N,N′-bis(3-methyl-5-neopentylsalicylidene)methanediamine]cobalt acetate, [N,N′-bis(3-methyl-5-neopentylsalicylidene)-1,2-ethane diamine]cobalt acetate, [N,N′-bis(3-methyl-5-neopentylsalicylidene)-1,3-propane diamine]cobalt acetate, [N,N′-bis(3-methyl-5-neopentylsalicylidene)-1,2-cyclopentanediamine]cobalt acetate, [N,N′-bis(3-methyl-5-neopentylsalicylidene)-1,3-cyclopentanediamine]cobalt acetate, [N,N′-bis(3-methyl-5-neopentylsalicylidene)-1,2-cyclohexane diamine]cobalt acetate, [N,N′-bis(3-methyl-5-neopentylsalicylidene)-1,3-cyclohexane diamine]cobalt acetate, [N,N′-bis(3-methyl-5-neopentylsalicylidene)-1,4-cyclohexane diamine]cobalt acetate, [N,N′-bis(3-methyl-5-neopentylsalicylidene)-1,2-norbornane diamine]cobalt acetate, [N,N′-bis(3-methyl-5-neopentylsalicylidene)-1,2-benzenediamine]cobalt acetate, [N,N′-bis(3-methyl-5-neopentylsalicylidene)-1,3-benzenediamine]cobalt acetate, [N,N′-bis(3-methyl-5-neopentylsalicylidene)-1,4-benzenediamine]cobalt acetate, [N,N′-bis(3-methyl-5-neopentylsalicylidene)-4-methoxy-1,2-benzenediamine]cobalt acetate, [N,N′-bis(3-methyl-5-neopentylsalicylidene)-2,3-naphthalene diamine]cobalt acetate, [N,N′-bis(3-methyl-5-neopentylsalicylidene)-1,8-naphthalenediamine]cobalt acetate, [N,N′-bis(5-isoamyl-3-methylsalicylidene)methanediamine]cobalt acetate, [N,N′-bis(5-isoamyl-3-methylsalicylidene)-1,2-ethane diamine]cobalt acetate, [N,N′-bis(5-isoamyl-3-methylsalicylidene)-1,3-propane diamine]cobalt acetate, [N,N′-bis(5-isoamyl-3-methylsalicylidene)-1,2-cyclopentane diamine]cobalt acetate, [N,N′-bis(5-isoamyl-3-methylsalicylidene)-1,3-cyclopentane diamine]cobalt acetate, [N,N′-bis(5-isoamyl-3-methylsalicylidene)-1,2-cyclohexane diamine]cobalt acetate, [N,N′-bis(5-isoamyl-3-methylsalicylidene)-1,3-cyclohexane diamine]cobalt acetate, [N,N′-bis(5-isoamyl-3-methylsalicylidene)-1,4-cyclohexane diamine]cobalt acetate, [N,N′-bis(5-isoamyl-3-methylsalicylidene)-1,2-norbornane diamine]cobalt acetate, [N,N′-bis(5-isoamyl-3-methylsalicylidene)-1,2-benzene diamine]cobalt acetate, [N,N′-bis(5-isoamyl-3-methylsalicylidene)-1,3-benzene diamine]cobalt acetate, [N,N′-bis(5-isoamyl-3-methylsalicylidene)-1,4-benzene diamine]cobalt acetate, [N,N′-bis(5-isoamyl-3-methylsalicylidene)-4-methoxy-1,2-benzenediamine]cobalt acetate, [N,N′-bis(5-isoamyl-3-methylsalicylidene)-2,3-naphthalene diamine]cobalt acetate, [N,N′-bis(5-isoamyl-3-methylsalicylidene)-1,8-naphthalenediamine]cobalt acetate, [N,N′-bis(3-methyl-5-phenylsalicylidene)methanediamine]cobalt acetate, [N,N′-bis(3-methyl-5-phenylsalicylidene)-1,2-ethanediamine]cobalt acetate, [N,N′-bis(3-methyl-5-phenylsalicylidene)-1,3-propane diamine]cobalt acetate, [N,N′-bis(3-methyl-5-phenylsalicylidene)-1,2-cyclopentane diamine]cobalt acetate, [N,N′-bis(3-methyl-5-phenylsalicylidene)-1,3-cyclopentane diamine]cobalt acetate, [N,N′-bis(3-methyl-5-phenylsalicylidene)-1,2-cyclohexane diamine]cobalt acetate, [N,N′-bis(3-methyl-5-phenylsalicylidene)-1,3-cyclohexane diamine]cobalt acetate, [N,N′-bis(3-methyl-5-phenylsalicylidene)-1,4-cyclohexane diamine]cobalt acetate, [N,N′-bis(3-methyl-5-phenylsalicylidene)-1,2-norbornane diamine]cobalt acetate, [N,N′-bis(3-methyl-5-phenylsalicylidene)-1,2-benzene diamine]cobalt acetate, [N,N′-bis(3-methyl-5-phenylsalicylidene)-1,3-benzene diamine]cobalt acetate, [N,N′-bis(3-methyl-5-phenylsalicylidene)-1,4-benzene diamine]cobalt acetate, [N,N′-bis(3-methyl-5-phenylsalicylidene)-4-methoxy-1,2-benzenediamine]cobalt acetate, [N,N′-bis(3-methyl-5-phenylsalicylidene)-2,3-naphthalene diamine]cobalt acetate, [N,N′-bis(3-methyl-5-phenylsalicylidene)-1,8-naphthalenediamine]cobalt acetate, [N,N′-bis(3-methyl-5-trifluoromethylsalicylidene)methane diamine]cobalt acetate, [N,N′-bis(3-methyl-5-trifluoromethylsalicylidene)-1,2-ethanediamine]cobalt acetate, [N,N′-bis(3-methyl-5-trifluoromethylsalicylidene)-1,3-propanediamine]cobalt acetate, [N,N′-bis(3-methyl-5-trifluoromethylsalicylidene)-1,2-cyclopentanediamine]cobalt acetate, [N,N′-bis(3-methyl-5-trifluoromethylsalicylidene)-1,3-cyclopentanediamine]cobalt acetate, [N,N′-bis(3-methyl-5-trifluoromethylsalicylidene)-1,2-cyclohexanediamine]cobalt acetate, [N,N′-bis(3-methyl-5-trifluoromethylsalicylidene)-1,3-cyclohexanediamine]cobalt acetate, [N,N′-bis(3-methyl-5-trifluoromethylsalicylidene)-1,4-cyclohexanediamine]cobalt acetate, [N,N′-bis(3-methyl-5-trifluoromethylsalicylidene)-1,2-norbornanediamine]cobalt acetate, [N,N′-bis(3-methyl-5-trifluoromethylsalicylidene)-1,2-benzenediamine]cobalt acetate, [N,N′-bis(3-methyl-5-trifluoromethylsalicylidene)-1,3-benzenediamine]cobalt acetate, [N,N′-bis(3-methyl-5-trifluoromethylsalicylidene)-1,4-benzenediamine]cobalt acetate, [N,N′-bis(3-methyl-5-trifluoromethylsalicylidene)-4-methoxy-1,2-benzenediamine]cobalt acetate, [N,N′-bis(3-methyl-5-trifluoromethylsalicylidene)-2,3-naphthalenediamine]cobalt acetate, [N,N′-bis(3-methyl-5-trifluoromethylsalicylidene)-1,8-naphthalenediamine]cobalt acetate, [N,N′-bis(3-methyl-5-trimethylsilylsalicylidene)methanediamine]cobalt acetate, [N,N′-bis(3-methyl-5-trimethylsilylsalicylidene)-1,2-ethanediamine]cobalt acetate, [N,N′-bis(3-methyl-5-trimethylsilylsalicylidene)-1,3-propanediamine]cobalt acetate, [N,N′-bis(3-methyl-5-trimethylsilylsalicylidene)-1,2-cyclopentanediamine]cobalt acetate, [N,N′-bis(3-methyl-5-trimethylsilylsalicylidene)-1,3-cyclopentanediamine]cobalt acetate, [N,N′-bis(3-methyl-5-trimethylsilylsalicylidene)-1,2-cyclohexanediamine]cobalt acetate, [N,N′-bis(3-methyl-5-trimethylsilylsalicylidene)-1,3-cyclohexanediamine]cobalt acetate, [N,N′-bis(3-methyl-5-trimethylsilylsalicylidene)-1,4-cyclohexanediamine]cobalt acetate, [N,N′-bis(3-methyl-5-trimethylsilylsalicylidene)-1,2-norbornanediamine]cobalt acetate, [N,N′-bis(3-methyl-5-trimethylsilylsalicylidene)-1,2-benzenediamine]cobalt acetate, [N,N′-bis(3-methyl-5-trimethylsilylsalicylidene)-1,3-benzenediamine]cobalt acetate, [N,N′-bis(3-methyl-5-trimethylsilylsalicylidene)-1,4-benzenediamine]cobalt acetate, [N,N′-bis(3-methyl-5-trimethylsilylsalicylidene)-4-methoxy-1,2-benzenediamine]cobalt acetate, [N,N′-bis(3-methyl-5-trimethylsilylsalicylidene)-2,3-naphthalenediamine]cobalt acetate, [N,N′-bis(3-methyl-5-trimethylsilylsalicylidene)-1,8-naphthalenediamine]cobalt acetate, and compounds obtained by changing the term “acetate” contained in the above compounds to the term “propionate”, “n-butyrate”, “isobutyrate”, “n-pentyrate”, “isopentyrate”, “sec-pentyrate”, “tert-pentyrate”, “trifluoroacetate”, “benzoate”, “fluoride”, “chloride”, “bromide”, “iodide”, “methoxide”, “ethoxide”, “isopropoxide”, “tert-butoxide”, “phenoxide”, “pentafluorophenoxide”, “benzyloxide”, “dimethylamide”, “diethylamide”, “hydroxide”, or “cyanide”.

Further, examples of the cobalt complex represented by formula (3) are as follows: [N,N′-bis(3-ethyl-5-methylsalicylidene)methanediamine]cobalt acetate, [N,N′-bis(3-ethyl-5-methylsalicylidene)-1,2-ethanediamine]cobalt acetate, [N,N′-bis(3-ethyl-5-methylsalicylidene)-1,3-propanediamine]cobalt acetate, [N,N′-bis(3-ethyl-5-methylsalicylidene)-1,2-cyclopentane diamine]cobalt acetate, [N,N′-bis(3-ethyl-5-methylsalicylidene)-1,3-cyclopentane diamine]cobalt acetate, [N,N′-bis(3-ethyl-5-methylsalicylidene)-1,2-cyclohexane diamine]cobalt acetate, [N,N′-bis(3-ethyl-5-methylsalicylidene)-1,3-cyclohexane diamine]cobalt acetate, [N,N′-bis(3-ethyl-5-methylsalicylidene)-1,4-cyclohexane diamine]cobalt acetate, [N,N′-bis(3-ethyl-5-methylsalicylidene)-1,2-norbornane diamine]cobalt acetate, [N,N′-bis(3-ethyl-5-methylsalicylidene)-1,2-benzenediamine]cobalt acetate, [N,N′-bis(3-ethyl-5-methylsalicylidene)-1,3-benzenediamine]cobalt acetate, [N,N′-bis(3-ethyl-5-methylsalicylidene)-1,4-benzenediamine]cobalt acetate, [N,N′-bis(3-ethyl-5-methylsalicylidene)-4-methoxy-1,2-benzenediamine]cobalt acetate, [N,N′-bis(3-ethyl-5-methylsalicylidene)-2,3-naphthalene diamine]cobalt acetate, [N,N′-bis(3-ethyl-5-methylsalicylidene)-1,8-naphthalenediamine]cobalt acetate, [N,N′-bis(3-ethyl-5-n-propylsalicylidene)methanediamine]cobalt acetate, [N,N′-bis(3-ethyl-5-n-propylsalicylidene)-1,2-ethane diamine]cobalt acetate, [N,N′-bis(3-ethyl-5-n-propylsalicylidene)-1,3-propane diamine]cobalt acetate, [N,N′-bis(3-ethyl-5-n-propylsalicylidene)-1,2-cyclopentane diamine]cobalt acetate, [N,N′-bis(3-ethyl-5-n-propylsalicylidene)-1,3-cyclopentane diamine]cobalt acetate, [N,N′-bis(3-ethyl-5-n-propylsalicylidene)-1,2-cyclohexane diamine]cobalt acetate, [N,N′-bis(3-ethyl-5-n-propylsalicylidene)-1,3-cyclohexane diamine]cobalt acetate, [N,N′-bis(3-ethyl-5-n-propylsalicylidene)-1,4-cyclohexane diamine]cobalt acetate, [N,N′-bis(3-ethyl-5-n-propylsalicylidene)-1,2-norbornane diamine]cobalt acetate, [N,N′-bis(3-ethyl-5-n-propylsalicylidene)-1,2-benzene diamine]cobalt acetate, [N,N′-bis(3-ethyl-5-n-propylsalicylidene)-1,3-benzene diamine]cobalt acetate, [N,N′-bis(3-ethyl-5-n-propylsalicylidene)-1,4-benzene diamine]cobalt acetate, [N,N′-bis(3-ethyl-5-n-propylsalicylidene)-4-methoxy-1,2-benzenediamine]cobalt acetate, [N,N′-bis(3-ethyl-5-n-propylsalicylidene)-2,3-naphthalene diamine]cobalt acetate, [N,N′-bis(3-ethyl-5-n-propylsalicylidene)-1,8-naphthalenediamine]cobalt acetate, [N,N′-bis(3-ethyl-5-isopropylsalicylidene)methanediamine]cobalt acetate, [N,N′-bis(3-ethyl-5-isopropylsalicylidene)-1,2-ethane diamine]cobalt acetate, [N,N′-bis(3-ethyl-5-isopropylsalicylidene)-1,3-propane diamine]cobalt acetate, [N,N′-bis(3-ethyl-5-isopropylsalicylidene)-1,2-cyclopentane diamine]cobalt acetate, [N,N′-bis(3-ethyl-5-isopropylsalicylidene)-1,3-cyclopentane diamine]cobalt acetate, [N,N′-bis(3-ethyl-5-isopropylsalicylidene)-1,2-cyclohexane diamine]cobalt acetate, [N,N′-bis(3-ethyl-5-isopropylsalicylidene)-1,3-cyclohexane diamine]cobalt acetate, [N,N′-bis(3-ethyl-5-isopropylsalicylidene)-1,4-cyclohexane diamine]cobalt acetate, [N,N′-bis(3-ethyl-5-isopropylsalicylidene)-1,2-norbornane diamine]cobalt acetate, [N,N′-bis(3-ethyl-5-isopropylsalicylidene)-1,2-benzene diamine]cobalt acetate, [N,N′-bis(3-ethyl-5-isopropylsalicylidene)-1,3-benzene diamine]cobalt acetate, [N,N′-bis(3-ethyl-5-isopropylsalicylidene)-1,4-benzene diamine]cobalt acetate, [N,N′-bis(3-ethyl-5-isopropylsalicylidene)-4-methoxy-1,2-benzenediamine]cobalt acetate, [N,N′-bis(3-ethyl-5-isopropylsalicylidene)-2,3-naphthalene diamine]cobalt acetate, [N,N′-bis(3-ethyl-5-isopropylsalicylidene)-1,8-naphthalenediamine]cobalt acetate, [N,N′-bis(5-n-butyl-3-ethylsalicylidene)methanediamine]cobalt acetate, [N,N′-bis(5-n-butyl-3-ethylsalicylidene)-1,2-ethanediamine]cobalt acetate, [N,N′-bis(5-n-butyl-3-ethylsalicylidene)-1,3-propane diamine]cobalt acetate, [N,N′-bis(5-n-butyl-3-ethylsalicylidene)-1,2-cyclopentane diamine]cobalt acetate, [N,N′-bis(5-n-butyl-3-ethylsalicylidene)-1,3-cyclopentane diamine]cobalt acetate, [N,N′-bis(5-n-butyl-3-ethylsalicylidene)-1,2-cyclohexane diamine]cobalt acetate, [N,N′-bis(5-n-butyl-3-ethylsalicylidene)-1,3-cyclohexane acetate, diamine]cobalt [N,N′-bis(5-n-butyl-3-ethylsalicylidene)-1,4-cyclohexane diamine]cobalt acetate, [N,N′-bis(5-n-butyl-3-ethylsalicylidene)-1,2-norbornane diamine]cobalt acetate, [N,N′-bis(5-n-butyl-3-ethylsalicylidene)-1,2-benzene diamine]cobalt acetate, [N,N′-bis(5-n-butyl-3-ethylsalicylidene)-1,3-benzene diamine]cobalt acetate, [N,N′-bis(5-n-butyl-3-ethylsalicylidene)-1,4-benzene acetate, diamine]cobalt [N,N′-bis(5-n-butyl-3-ethylsalicylidene)-4-methoxy-1,2-benzenediamine]cobalt acetate, [N,N′-bis(5-n-butyl-3-ethylsalicylidene)-2,3-naphthalene acetate, diamine]cobalt [N,N′-bis(5-n-butyl-3-ethylsalicylidene)-1,8-naphthalenediamine]cobalt acetate, [N,N′-bis(5-isobutyl-3-ethylsalicylidene)methanediamine]cobalt acetate, [N,N′-bis(5-isobutyl-3-ethylsalicylidene)-1,2-ethane diamine]cobalt acetate, [N,N′-bis(5-isobutyl-3-ethylsalicylidene)-1,3-propane diamine]cobalt acetate, [N,N′-bis(5-isobutyl-3-ethylsalicylidene)-1,2-cyclopentane diamine]cobalt acetate, [N,N′-bis(5-isobutyl-3-ethylsalicylidene)-1,3-cyclopentane diamine]cobalt acetate, [N,N′-bis(5-isobutyl-3-ethylsalicylidene)-1,2-cyclohexane diamine]cobalt acetate, [N,N′-bis(5-isobutyl-3-ethylsalicylidene)-1,3-cyclohexane diamine]cobalt acetate, [N,N′-bis(5-isobutyl-3-ethylsalicylidene)-1,4-cyclohexane diamine]cobalt acetate, [N,N′-bis(5-isobutyl-3-ethylsalicylidene)-1,2-norbornane diamine]cobalt acetate, [N,N′-bis(5-isobutyl-3-ethylsalicylidene)-1,2-benzene diamine]cobalt acetate, [N,N′-bis(5-isobutyl-3-ethylsalicylidene)-1,3-benzene diamine]cobalt acetate, [N,N′-bis(5-isobutyl-3-ethylsalicylidene)-1,4-benzene diamine]cobalt acetate, [N,N′-bis(5-isobutyl-3-ethylsalicylidene)-4-methoxy-1,2-benzenediamine]cobalt acetate, [N,N′-bis(5-isobutyl-3-ethylsalicylidene)-2,3-naphthalene diamine]cobalt acetate, [N,N′-bis(5-isobutyl-3-ethylsalicylidene)-1,8-naphthalenediamine]cobalt acetate, [N,N′-bis(5-sec-butyl-3-ethylsalicylidene)methanediamine]cobalt acetate, [N,N′-bis(5-sec-butyl-3-ethylsalicylidene)-1,2-ethane diamine]cobalt acetate, [N,N′-bis(5-sec-butyl-3-ethylsalicylidene)-1,3-propane diamine]cobalt acetate, [N,N′-bis(5-sec-butyl-3-ethylsalicylidene)-1,2-cyclopentane diamine]cobalt acetate, [N,N′-bis(5-sec-butyl-3-ethylsalicylidene)-1,3-cyclopentane diamine]cobalt acetate, [N,N′-bis(5-sec-butyl-3-ethylsalicylidene)-1,2-cyclohexane diamine]cobalt acetate, [N,N′-bis(5-sec-butyl-3-ethylsalicylidene)-1,3-cyclohexane diamine]cobalt acetate, [N,N′-bis(5-sec-butyl-3-ethylsalicylidene)-1,4-cyclohexane diamine]cobalt acetate, [N,N′-bis(5-sec-butyl-3-ethylsalicylidene)-1,2-norbornane diamine]cobalt acetate, [N,N′-bis(5-sec-butyl-3-ethylsalicylidene)-1,2-benzene diamine]cobalt acetate, [N,N′-bis(5-sec-butyl-3-ethylsalicylidene)-1,3-benzene diamine]cobalt acetate, [N,N′-bis(5-sec-butyl-3-ethylsalicylidene)-1,4-benzene diamine]cobalt acetate, [N,N′-bis(5-sec-butyl-3-ethylsalicylidene)-4-methoxy-1,2-benzenediamine]cobalt acetate, [N,N′-bis(5-sec-butyl-3-ethylsalicylidene)-2,3-naphthalene diamine]cobalt acetate, [N,N′-bis(5-sec-butyl-3-ethylsalicylidene)-1,8-naphthalenediamine]cobalt acetate, [N,N′-bis(5-tert-butyl-3-methylsalicylidene)methanediamine]cobalt acetate, [N,N′-bis(5-tert-butyl-3-methylsalicylidene)-1,2-ethane diamine]cobalt acetate, [N,N′-bis(5-tert-butyl-3-methylsalicylidene)-1,3-propane diamine]cobalt acetate, [N,N′-bis(5-tert-butyl-3-methylsalicylidene)-1,2-cyclopentanediamine]cobalt acetate, [N,N′-bis(5-tert-butyl-3-methylsalicylidene)-1,3-cyclopentanediamine]cobalt acetate, [N,N′-bis(5-tert-butyl-3-methylsalicylidene)-1,2-cyclohexanediamine]cobalt acetate, [N,N′-bis(5-tert-butyl-3-methylsalicylidene)-1,3-cyclohexanediamine]cobalt acetate, [N,N′-bis(5-tert-butyl-3-methylsalicylidene)-1,4-cyclohexanediamine]cobalt acetate, [N,N′-bis(5-tert-butyl-3-methylsalicylidene)-1,2-norbornane diamine]cobalt acetate, [N,N′-bis(5-tert-butyl-3-methylsalicylidene)-1,2-benzene diamine]cobalt acetate, [N,N′-bis(5-tert-butyl-3-methylsalicylidene)-1,3-benzene diamine]cobalt acetate, [N,N′-bis(5-tert-butyl-3-methylsalicylidene)-1,4-benzene diamine]cobalt acetate, [N,N′-bis(5-tert-butyl-3-methylsalicylidene)-4-methoxy-1,2-benzenediamine]cobalt acetate, [N,N′-bis(5-tert-butyl-3-methylsalicylidene)-2,3-naphthalenediamine]cobalt acetate, [N,N′-bis(5-tert-butyl-3-methylsalicylidene)-1,8-naphthalenediamine]cobalt acetate, [N,N′-bis(3-ethyl-5-neopentylsalicylidene)methanediamine]cobalt acetate, [N,N′-bis(3-ethyl-5-neopentylsalicylidene)-1,2-ethane diamine]cobalt acetate, [N,N′-bis(3-ethyl-5-neopentylsalicylidene)-1,3-propane diamine]cobalt acetate, [N,N′-bis(3-ethyl-5-neopentylsalicylidene)-1,2-cyclopentane diamine]cobalt acetate, [N,N′-bis(3-ethyl-5-neopentylsalicylidene)-1,3-cyclopentane diamine]cobalt acetate, [N,N′-bis(3-ethyl-5-neopentylsalicylidene)-1,2-cyclohexane diamine]cobalt acetate, [N,N′-bis(3-ethyl-5-neopentylsalicylidene)-1,3-cyclohexane diamine]cobalt acetate, [N,N′-bis(3-ethyl-5-neopentylsalicylidene)-1,4-cyclohexane diamine]cobalt acetate, [N,N′-bis(3-ethyl-5-neopentylsalicylidene)-1,2-norbornanediamine]cobalt acetate, [N,N′-bis(3-ethyl-5-neopentylsalicylidene)-1,2-benzene diamine]cobalt acetate, [N,N′-bis(3-ethyl-5-neopentylsalicylidene)-1,3-benzene diamine]cobalt acetate, [N,N′-bis(3-ethyl-5-neopentylsalicylidene)-1,4-benzene diamine]cobalt acetate, [N,N′-bis(3-ethyl-5-neopentylsalicylidene)-4-methoxy-1,2-benzenediamine]cobalt acetate, [N,N′-bis(3-ethyl-5-neopentylsalicylidene)-2,3-naphthalene diamine]cobalt acetate, [N,N′-bis(3-ethyl-5-neopentylsalicylidene)-1,8-naphthalenediamine]cobalt acetate, [N,N′-bis(5-isoamyl-3-ethylsalicylidene)methanediamine]cobalt acetate, [N,N′-bis(5-isoamyl-3-ethylsalicylidene)-1,2-ethanediamine]cobalt acetate, [N,N′-bis(5-isoamyl-3-ethylsalicylidene)-1,3-propane diamine]cobalt acetate, [N,N′-bis(5-isoamyl-3-ethylsalicylidene)-1,2-cyclopentane diamine]cobalt acetate, [N,N′-bis(5-isoamyl-3-ethylsalicylidene)-1,3-cyclopentane diamine]cobalt acetate, [N,N′-bis(5-isoamyl-3-ethylsalicylidene)-1,2-cyclohexane diamine]cobalt acetate, [N,N′-bis(5-isoamyl-3-ethylsalicylidene)-1,3-cyclohexane diamine]cobalt acetate, [N,N′-bis(5-isoamyl-3-ethylsalicylidene)-1,4-cyclohexane diamine]cobalt acetate, [N,N′-bis(5-isoamyl-3-ethylsalicylidene)-1,2-norbornane diamine]cobalt acetate, [N,N′-bis(5-isoamyl-3-ethylsalicylidene)-1,2-benzene diamine]cobalt acetate, [N,N′-bis(5-isoamyl-3-ethylsalicylidene)-1,3-benzene diamine]cobalt acetate, [N,N′-bis(5-isoamyl-3-ethylsalicylidene)-1,4-benzene diamine]cobalt acetate, [N,N′-bis(5-isoamyl-3-ethylsalicylidene)-4-methoxy-1,2-benzenediamine]cobalt acetate, [N,N′-bis(5-isoamyl-3-ethylsalicylidene)-2,3-naphthalene diamine]cobalt acetate, [N,N′-bis(5-isoamyl-3-ethylsalicylidene)-1,8-naphthalenediamine]cobalt acetate, [N,N′-bis(3-ethyl-5-phenylsalicylidene)methanediamine]cobalt acetate, [N,N′-bis(3-ethyl-5-phenylsalicylidene)-1,2-ethanediamine]cobalt acetate, [N,N′-bis(3-ethyl-5-phenylsalicylidene)-1,3-propanediamine]cobalt acetate, [N,N′-bis(3-ethyl-5-phenylsalicylidene)-1,2-cyclopentane diamine]cobalt acetate, [N,N′-bis(3-ethyl-5-phenylsalicylidene)-1,3-cyclopentane diamine]cobalt acetate, [N,N′-bis(3-ethyl-5-phenylsalicylidene)-1,2-cyclohexane diamine]cobalt acetate, [N,N′-bis(3-ethyl-5-phenylsalicylidene)-1,3-cyclohexane diamine]cobalt acetate, [N,N′-bis(3-ethyl-5-phenylsalicylidene)-1,4-cyclohexane diamine]cobalt acetate, [N,N′-bis(3-ethyl-5-phenylsalicylidene)-1,2-norbornane diamine]cobalt acetate, [N,N′-bis(3-ethyl-5-phenylsalicylidene)-1,2-benzenediamine]cobalt acetate, [N,N′-bis(3-ethyl-5-phenylsalicylidene)-1,3-benzenediamine]cobalt acetate, [N,N′-bis(3-ethyl-5-phenylsalicylidene)-1,4-benzenediamine]cobalt acetate, [N,N′-bis(3-ethyl-5-phenylsalicylidene)-4-methoxy-1,2-benzenediamine]cobalt acetate, [N,N′-bis(3-ethyl-5-phenylsalicylidene)-2,3-naphthalene diamine]cobalt acetate, [N,N′-bis(3-ethyl-5-phenylsalicylidene)-1,8-naphthalenediamine]cobalt acetate, [N,N′-bis(3-ethyl-5-trifluoromethylsalicylidene)methane diamine]cobalt acetate, [N,N′-bis(3-ethyl-5-trifluoromethylsalicylidene)-1,2-ethanediamine]cobalt acetate, [N,N′-bis(3-ethyl-5-trifluoromethylsalicylidene)-1,3-propanediamine]cobalt acetate, [N,N′-bis(3-ethyl-5-trifluoromethylsalicylidene)-1,2-cyclopentanediamine]cobalt acetate, [N,N′-bis(3-ethyl-5-trifluoromethylsalicylidene)-1,3-cyclopentanediamine]cobalt acetate, [N,N′-bis(3-ethyl-5-trifluoromethylsalicylidene)-1,2-cyclohexanediamine]cobalt acetate, [N,N′-bis(3-ethyl-5-trifluoromethylsalicylidene)-1,3-cyclohexanediamine]cobalt acetate, [N,N′-bis(3-ethyl-5-trifluoromethylsalicylidene)-1,4-cyclohexanediamine]cobalt acetate, [N,N′-bis(3-ethyl-5-trifluoromethylsalicylidene)-1,2-norbornanediamine]cobalt acetate, [N,N′-bis(3-ethyl-5-trifluoromethylsalicylidene)-1,2-benzenediamine]cobalt acetate, [N,N′-bis(3-ethyl-5-trifluoromethylsalicylidene)-1,3-benzenediamine]cobalt acetate, [N,N′-bis(3-ethyl-5-trifluoromethylsalicylidene)-1,4-benzenediamine]cobalt acetate, [N,N′-bis(3-ethyl-5-trifluoromethylsalicylidene)-4-methoxy-1,2-benzenediamine]cobalt acetate, [N,N′-bis(3-ethyl-5-trifluoromethylsalicylidene)-2,3-naphthalenediamine]cobalt acetate, [N,N′-bis(3-ethyl-5-trifluoromethylsalicylidene)-1,8-naphthalenediamine]cobalt acetate, [N,N′-bis(3-ethyl-5-trimethylsilylsalicylidene)methane diamine]cobalt acetate, [N,N′-bis(3-ethyl-5-trimethylsilylsalicylidene)-1,2-ethane diamine]cobalt acetate, [N,N′-bis(3-ethyl-5-trimethylsilylsalicylidene)-1,3-propane diamine]cobalt acetate, [N,N′-bis(3-ethyl-5-trimethylsilylsalicylidene)-1,2-cyclopentanediamine]cobalt acetate, [N,N′-bis(3-ethyl-5-trimethylsilylsalicylidene)-1,3-cyclopentanediamine]cobalt acetate, [N,N′-bis(3-ethyl-5-trimethylsilylsalicylidene)-1,2-cyclohexanediamine]cobalt acetate, [N,N′-bis(3-ethyl-5-trimethylsilylsalicylidene)-1,3-cyclohexanediamine]cobalt acetate, [N,N′-bis(3-ethyl-5-trimethylsilylsalicylidene)-1,4-cyclohexanediamine]cobalt acetate, [N,N′-bis(3-ethyl-5-trimethylsilylsalicylidene)-1,2-norbornanediamine]cobalt acetate, [N,N′-bis(3-ethyl-5-trimethylsilylsalicylidene)-1,2-benzene diamine]cobalt acetate, [N,N′-bis(3-ethyl-5-trimethylsilylsalicylidene)-1,3-benzene diamine]cobalt acetate, [N,N′-bis(3-ethyl-5-trimethylsilylsalicylidene)-1,4-benzene diamine]cobalt acetate, [N,N′-bis(3-ethyl-5-trimethylsilylsalicylidene)-4-methoxy-1,2-benzenediamine]cobalt acetate, [N,N′-bis(3-ethyl-5-trimethylsilylsalicylidene)-2,3-naphthalenediamine]cobalt acetate, [N,N′-bis(3-ethyl-5-trimethylsilylsalicylidene)-1,8-naphthalenediamine]cobalt acetate, and compounds obtained by changing the term “acetate” contained in the above compounds to the term “propionate”, “n-butyrate”, “isobutyrate”, “n-pentyrate”, “isopentyrate”, “sec-pentyrate”, “tert-pentyrate”, “trifluoroacetate”, “benzoate”, “fluoride”, “chloride”, “bromide”, “iodide”, “methoxide”, “ethoxide”, “isopropoxide”, “tert-butoxide”, “phenoxide”, “pentafluorophenoxide”, “benzyloxide”, “dimethylamide”, “diethylamide”, “hydroxide”, or “cyanide”.

Still further, examples of the cobalt complex represented by formula (3) are as follows: [N,N′-bis(5-methyl-3-isopropylsalicylidene)methanediamine]cobalt acetate, [N,N′-bis(5-methyl-3-isopropylsalicylidene)-1,2-ethane diamine]cobalt acetate, [N,N′-bis(5-methyl-3-isopropylsalicylidene)-1,3-propane diamine]cobalt acetate, [N,N′-bis(5-methyl-3-isopropylsalicylidene)-1,2-cyclopentanediamine]cobalt acetate, [N,N′-bis(5-methyl-3-isopropylsalicylidene)-1,3-cyclopentanediamine]cobalt acetate, [N,N′-bis(5-methyl-3-isopropylsalicylidene)-1,2-cyclohexane diamine]cobalt acetate, [N,N′-bis(5-methyl-3-isopropylsalicylidene)-1,3-cyclohexane diamine]cobalt acetate, [N,N′-bis(5-methyl-3-isopropylsalicylidene)-1,4-cyclohexane diamine]cobalt acetate, [N,N′-bis(5-methyl-3-isopropylsalicylidene)-1,2-norbornane diamine]cobalt acetate, [N,N′-bis(5-methyl-3-isopropylsalicylidene)-1,2-benzene diamine]cobalt acetate, [N,N′-bis(5-methyl-3-isopropylsalicylidene)-1,3-benzene diamine]cobalt acetate, [N,N′-bis(5-methyl-3-isopropylsalicylidene)-1,4-benzene diamine]cobalt acetate, [N,N′-bis(5-methyl-3-isopropylsalicylidene)-4-methoxy-1,2-benzenediamine]cobalt acetate, [N,N′-bis(5-methyl-3-isopropylsalicylidene)-2,3-naphthalene diamine]cobalt acetate, [N,N′-bis(5-methyl-3-isopropylsalicylidene)-1,8-naphthalenediamine]cobalt acetate, [N,N′-bis(5-ethyl-3-isopropylsalicylidene)methanediamine]cobalt acetate, [N,N′-bis(5-ethyl-3-isopropylsalicylidene)-1,2-ethane diamine]cobalt acetate, [N,N′-bis(5-ethyl-3-isopropylsalicylidene)-1,3-propane diamine]cobalt acetate, [N,N′-bis(5-ethyl-3-isopropylsalicylidene)-1,2-cyclopentane diamine]cobalt acetate, [N,N′-bis(5-ethyl-3-isopropylsalicylidene)-1,3-cyclopentane diamine]cobalt acetate, [N,N′-bis(5-ethyl-3-isopropylsalicylidene)-1,2-cyclohexane diamine]cobalt acetate, [N,N′-bis(5-ethyl-3-isopropylsalicylidene)-1,3-cyclohexane diamine]cobalt acetate, [N,N′-bis(5-ethyl-3-isopropylsalicylidene)-1,4-cyclohexane diamine]cobalt acetate, [N,N′-bis(5-ethyl-3-isopropylsalicylidene)-1,2-norbornane diamine]cobalt acetate, [N,N′-bis(5-ethyl-3-isopropylsalicylidene)-1,2-benzene diamine]cobalt acetate, [N,N′-bis(5-ethyl-3-isopropylsalicylidene)-1,3-benzene diamine]cobalt acetate, [N,N′-bis(5-ethyl-3-isopropylsalicylidene)-1,4-benzene diamine]cobalt acetate, [N,N′-bis(5-ethyl-3-isopropylsalicylidene)-4-methoxy-1,2-benzenediamine]cobalt acetate, [N,N′-bis(5-ethyl-3-isopropylsalicylidene)-2,3-naphthalene diamine]cobalt acetate, [N,N′-bis(5-ethyl-3-isopropylsalicylidene)-1,8-naphthalenediamine]cobalt acetate, [N,N′-bis(3-isopropyl-5-n-propylsalicylidene)methane diamine]cobalt acetate, [N,N′-bis(3-isopropyl-5-n-propylsalicylidene)-1,2-ethane diamine]cobalt acetate, [N,N′-bis(3-isopropyl-5-n-propylsalicylidene)-1,3-propane diamine]cobalt acetate, [N,N′-bis(3-isopropyl-5-n-propylsalicylidene)-1,2-cyclopentanediamine]cobalt acetate, [N,N′-bis(3-isopropyl-5-n-propylsalicylidene)-1,3-cyclopentanediamine]cobalt acetate, [N,N′-bis(3-isopropyl-5-n-propylsalicylidene)-1,2-cyclohexanediamine]cobalt acetate, [N,N′-bis(3-isopropyl-5-n-propylsalicylidene)-1,3-cyclohexanediamine]cobalt acetate, [N,N′-bis(3-isopropyl-5-n-propylsalicylidene)-1,4-cyclohexanediamine]cobalt acetate, [N,N′-bis(3-isopropyl-5-n-propylsalicylidene)-1,2-norbornanediamine]cobalt acetate, [N,N′-bis(3-isopropyl-5-n-propylsalicylidene)-1,2-benzene diamine]cobalt acetate, [N,N′-bis(3-isopropyl-5-n-propylsalicylidene)-1,3-benzene diamine]cobalt acetate, [N,N′-bis(3-isopropyl-5-n-propylsalicylidene)-1,4-benzene diamine]cobalt acetate, [N,N′-bis(3-isopropyl-5-n-propylsalicylidene)-4-methoxy-1,2-benzenediamine]cobalt acetate, [N,N′-bis(3-isopropyl-5-n-propylsalicylidene)-2,3-naphthalenediamine]cobalt acetate, [N,N′-bis(3-isopropyl-5-n-propylsalicylidene)-1,8-naphthalenediamine]cobalt acetate, [N,N′-bis(5-n-butyl-3-isopropylsalicylidene)methanediamine]cobalt acetate, [N,N′-bis(5-n-butyl-3-isopropylsalicylidene)-1,2-ethane diamine]cobalt acetate, [N,N′-bis(5-n-butyl-3-isopropylsalicylidene)-1,3-propane diamine]cobalt acetate, [N,N′-bis(5-n-butyl-3-isopropylsalicylidene)-1,2-cyclopentanediamine]cobalt acetate, [N,N′-bis(5-n-butyl-3-isopropylsalicylidene)-1,3-cyclopentanediamine]cobalt acetate, [N,N′-bis(5-n-butyl-3-isopropylsalicylidene)-1,2-cyclohexanediamine]cobalt acetate, [N,N′-bis(5-n-butyl-3-isopropylsalicylidene)-1,3-cyclohexanediamine]cobalt acetate, [N,N′-bis(5-n-butyl-3-isopropylsalicylidene)-1,4-cyclohexanediamine]cobalt acetate, [N,N′-bis(5-n-butyl-3-isopropylsalicylidene)-1,2-norbornane diamine]cobalt acetate, [N,N′-bis(5-n-butyl-3-isopropylsalicylidene)-1,2-benzene diamine]cobalt acetate, [N,N′-bis(5-n-butyl-3-isopropylsalicylidene)-1,3-benzene diamine]cobalt acetate, [N,N′-bis(5-n-butyl-3-isopropylsalicylidene)-1,4-benzene diamine]cobalt acetate, [N,N′-bis(5-n-butyl-3-isopropylsalicylidene)-4-methoxy-1,2-benzenediamine]cobalt acetate, [N,N′-bis(5-n-butyl-3-isopropylsalicylidene)-2,3-naphthalenediamine]cobalt acetate, [N,N′-bis(5-n-butyl-3-isopropylsalicylidene)-1,8-naphthalenediamine]cobalt acetate, [N,N′-bis(5-isobutyl-3-isopropylsalicylidene)methane diamine]cobalt acetate, [N,N′-bis(5-isobutyl-3-isopropylsalicylidene)-1,2-ethane diamine]cobalt acetate, [N,N′-bis(5-isobutyl-3-isopropylsalicylidene)-1,3-propane diamine]cobalt acetate, [N,N′-bis(5-isobutyl-3-isopropylsalicylidene)-1,2-cyclopentanediamine]cobalt acetate, [N,N′-bis(5-isobutyl-3-isopropylsalicylidene)-1,3-cyclopentanediamine]cobalt acetate, [N,N′-bis(5-isobutyl-3-isopropylsalicylidene)-1,2-cyclohexanediamine]cobalt acetate, [N,N′-bis(5-isobutyl-3-isopropylsalicylidene)-1,3-cyclohexanediamine]cobalt acetate, [N,N′-bis(5-isobutyl-3-isopropylsalicylidene)-1,4-cyclohexanediamine]cobalt acetate, [N,N′-bis(5-isobutyl-3-isopropylsalicylidene)-1,2-norbornanediamine]cobalt acetate, [N,N′-bis(5-isobutyl-3-isopropylsalicylidene)-1,2-benzene diamine]cobalt acetate, [N,N′-bis(5-isobutyl-3-isopropylsalicylidene)-1,3-benzene diamine]cobalt acetate, [N,N′-bis(5-isobutyl-3-isopropylsalicylidene)-1,4-benzene diamine]cobalt acetate, [N,N′-bis(5-isobutyl-3-isopropylsalicylidene)-4-methoxy-1,2-benzenediamine]cobalt acetate, [N,N′-bis(5-isobutyl-3-isopropylsalicylidene)-2,3-naphthalenediamine]cobalt acetate, [N,N′-bis(5-isobutyl-3-isopropylsalicylidene)-1,8-naphthalenediamine]cobalt acetate, [N,N′-bis(5-sec-butyl-3-isopropylsalicylidene)methane diamine]cobalt acetate, [N,N′-bis(5-sec-butyl-3-isopropylsalicylidene)-1,2-ethane diamine]cobalt acetate, [N,N′-bis(5-sec-butyl-3-isopropylsalicylidene)-1,3-propane diamine]cobalt acetate, [N,N′-bis(5-sec-butyl-3-isopropylsalicylidene)-1,2-cyclopentanediamine]cobalt acetate, [N,N′-bis(5-sec-butyl-3-isopropylsalicylidene)-1,3-cyclopentanediamine]cobalt acetate, [N,N′-bis(5-sec-butyl-3-isopropylsalicylidene)-1,2-cyclohexanediamine]cobalt acetate, [N,N′-bis(5-sec-butyl-3-isopropylsalicylidene)-1,3-cyclohexanediamine]cobalt acetate, [N,N′-bis(5-sec-butyl-3-isopropylsalicylidene)-1,4-cyclohexanediamine]cobalt acetate, [N,N′-bis(5-sec-butyl-3-isopropylsalicylidene)-1,2-norbornanediamine]cobalt acetate, [N,N′-bis(5-sec-butyl-3-isopropylsalicylidene)-1,2-benzene diamine]cobalt acetate, [N,N′-bis(5-sec-butyl-3-isopropylsalicylidene)-1,3-benzene diamine]cobalt acetate, [N,N′-bis(5-sec-butyl-3-isopropylsalicylidene)-1,4-benzene diamine]cobalt acetate, [N,N′-bis(5-sec-butyl-3-isopropylsalicylidene)-4-methoxy-1,2-benzenediamine]cobalt acetate, [N,N′-bis(5-sec-butyl-3-isopropylsalicylidene)-2,3-naphthalenediamine]cobalt acetate, [N,N′-bis(5-sec-butyl-3-isopropylsalicylidene)-1,8-naphthalenediamine]cobalt acetate, [N,N′-bis(5-tert-butyl-3-isopropylsalicylidene)methane diamine]cobalt acetate, [N,N′-bis(5-tert-butyl-3-isopropylsalicylidene)-1,2-ethane diamine]cobalt acetate, [N,N′-bis(5-tert-butyl-3-isopropylsancylidene)-1,3-propane diamine]cobalt acetate, [N,N′-bis(5-tert-butyl-3-isopropylsancylidene)-1,2-cyclopentanediamine]cobalt acetate, [N,N′-bis(5-tert-butyl-3-isopropylsancylidene)-1,3-cyclopentanediamine]cobalt acetate, [N,N′-bis(5-tert-butyl-3-isopropylsancylidene)-1,2-cyclohexanediamine]cobalt acetate, [N,N′-bis(5-tert-butyl-3-isopropylsalicylidene)-1,3-cyclohexanediamine]cobalt acetate, [N,N′-bis(5-tert-butyl-3-isopropylsalicylidene)-1,4-cyclohexanediamine]cobalt acetate, [N,N′-bis(5-tert-butyl-3-isopropylsalicylidene)-1,2-norbornanediamine]cobalt acetate, [N,N′-bis(5-tert-butyl-3-isopropylsalicylidene)-1,2-benzene diamine]cobalt acetate, [N,N′-bis(5-tert-butyl-3-isopropylsalicylidene)-1,3-benzene diamine]cobalt acetate, [N,N′-bis(5-tert-butyl-3-isopropylsalicylidene)-1,4-benzene diamine]cobalt acetate, [N,N′-bis(5-tert-butyl-3-isopropylsalicylidene)-4-methoxy-1,2-benzenediamine]cobalt acetate, [N,N′-bis(5-tert-butyl-3-isopropylsalicylidene)-2,3-naphthalenediamine]cobalt acetate, [N,N′-bis(5-tert-butyl-3-isopropylsalicylidene)-1,8-naphthalenediamine]cobalt acetate, [N,N′-bis(5-neopentyl-3-isopropylsalicylidene)methane diamine]cobalt acetate, [N,N′-bis(5-neopentyl-3-isopropylsalicylidene)-1,2-ethane diamine]cobalt acetate, [N,N′-bis(5-neopentyl-3-isopropylsalicylidene)-1,3-propane diamine]cobalt acetate, [N,N′-bis(5-neopentyl-3-isopropylsalicylidene)-1,2-cyclopentanediamine]cobalt acetate, [N,N′-bis(5-neopentyl-3-isopropylsalicylidene)-1,3-cyclopentanediamine]cobalt acetate, [N,N′-bis(5-neopentyl-3-isopropylsalicylidene)-1,2-cyclohexanediamine]cobalt acetate, [N,N′-bis(5-neopentyl-3-isopropylsalicylidene)-1,3-cyclohexanediamine]cobalt acetate, [N,N′-bis(5-neopentyl-3-isopropylsalicylidene)-1,4-cyclohexanediamine]cobalt acetate, [N,N′-bis(5-neopentyl-3-isopropylsalicylidene)-1,2-norbornanediamine]cobalt acetate, [N,N′-bis(5-neopentyl-3-isopropylsalicylidene)-1,2-benzene diamine]cobalt acetate, [N,N′-bis(5-neopentyl-3-isopropylsalicylidene)-1,3-benzene diamine]cobalt acetate, [N,N′-bis(5-neopentyl-3-isopropylsalicylidene)-1,4-benzene diamine]cobalt acetate, [N,N′-bis(5-neopentyl-3-isopropylsalicylidene)-4-methoxy-1,2-benzenediamine]cobalt acetate, [N,N′-bis(5-neopentyl-3-isopropylsalicylidene)-2,3-naphthalenediamine]cobalt acetate, [N,N′-bis(5-neopentyl-3-isopropylsalicylidene)-1,8-naphthalenediamine]cobalt acetate, [N,N′-bis(5-isoamyl-3-isopropylsalicylidene)methanediamine]cobalt acetate, [N,N′-bis(5-isoamyl-3-isopropylsalicylidene)-1,2-ethane diamine]cobalt acetate, [N,N′-bis(5-isoamyl-3-isopropylsalicylidene)-1,3-propane diamine]cobalt acetate, [N,N′-bis(5-isoamyl-3-isopropylsalicylidene)-1,2-cyclopentanediamine]cobalt acetate, [N,N′-bis(5-isoamyl-3-isopropylsalicylidene)-1,3-cyclopentanediamine]cobalt acetate, [N,N′-bis(5-isoamyl-3-isopropylsalicylidene)-1,2-cyclohexanediamine]cobalt acetate, [N,N′-bis(5-isoamyl-3-isopropylsalicylidene)-1,3-cyclohexanediamine]cobalt acetate, [N,N′-bis(5-isoamyl-3-isopropylsalicylidene)-1,4-cyclohexanediamine]cobalt acetate, [N,N′-bis(5-isoamyl-3-isopropylsalicylidene)-1,2-norbornane diamine]cobalt acetate, [N,N′-bis(5-isoamyl-3-isopropylsalicylidene)-1,2-benzene diamine]cobalt acetate, [N,N′-bis(5-isoamyl-3-isopropylsalicylidene)-1,3-benzene diamine]cobalt acetate, [N,N′-bis(5-isoamyl-3-isopropylsalicylidene)-1,4-benzene diamine]cobalt acetate, [N,N′-bis(5-isoamyl-3-isopropylsalicylidene)-4-methoxy-1,2-benzenediamine]cobalt acetate, [N,N′-bis(5-isoamyl-3-isopropylsalicylidene)-2,3-naphthalenediamine]cobalt acetate, [N,N′-bis(5-isoamyl-3-isopropylsalicylidene)-1,8-naphthalenediamine]cobalt acetate, [N,N′-bis(5-phenyl-3-isopropylsalicylidene)methanediamine]cobalt acetate, [N,N′-bis(5-phenyl-3-isopropylsalicylidene)-1,2-ethane diamine]cobalt acetate, [N,N′-bis(5-phenyl-3-isopropylsalicylidene)-1,3-propane acetate, diamine]cobalt [N,N′-bis(5-phenyl-3-isopropylsalicylidene)-1,2-cyclopentanediamine]cobalt acetate, [N,N′-bis(5-phenyl-3-isopropylsalicylidene)-1,3-cyclopentanediamine]cobalt acetate, [N,N′-bis(5-phenyl-3-isopropylsalicylidene)-1,2-cyclohexanediamine]cobalt acetate, [N,N′-bis(5-phenyl-3-isopropylsalicylidene)-1,3-cyclohexane diamine]cobalt acetate, [N,N′-bis(5-phenyl-3-isopropylsalicylidene)-1,4-cyclohexane diamine]cobalt acetate, [N,N′-bis(5-phenyl-3-isopropylsalicylidene)-1,2-norbornane diamine]cobalt acetate, [N,N′-bis(5-phenyl-3-isopropylsalicylidene)-1,2-benzene acetate, diamine]cobalt [N,N′-bis(5-phenyl-3-isopropylsalicylidene)-1,3-benzene diamine]cobalt acetate, [N,N′-bis(5-phenyl-3-isopropylsalicylidene)-1,4-benzene diamine]cobalt acetate, [N,N′-bis(5-phenyl-3-isopropylsalicylidene)-4-methoxy-1,2-benzenediamine]cobalt acetate, [N,N′-bis(5-phenyl-3-isopropylsalicylidene)-2,3-naphthalene diamine]cobalt acetate, [N,N′-bis(5-phenyl-3-isopropylsalicylidene)-1,8-naphthalenediamine]cobalt acetate, [N,N′-bis(5-trifluoromethyl-3-isopropylsalicylidene)methane diamine]cobalt acetate, [N,N′-bis(5-trifluoromethyl-3-isopropylsalicylidene)-1,2-ethanediamine]cobalt acetate, [N,N′-bis(5-trifluoromethyl-3-isopropylsalicylidene)-1,3-propanediamine]cobalt acetate, [N,N′-bis(5-trifluoromethyl-3-isopropylsalicylidene)-1,2-cyclopentanediamine]cobalt acetate, [N,N′-bis(5-trifluoromethyl-3-isopropylsalicylidene)-1,3-cyclopentanediamine]cobalt acetate, [N,N′-bis(5-trifluoromethyl-3-isopropylsalicylidene)-1,2-cyclohexanediamine]cobalt acetate, [N,N′-bis(5-trifluoromethyl-3-isopropylsalicylidene)-1,3-cyclohexanediamine]cobalt acetate, [N,N′-bis(5-trifluoromethyl-3-isopropylsalicylidene)-1,4-cyclohexanediamine]cobalt acetate, [N,N′-bis(5-trifluoromethyl-3-isopropylsalicylidene)-1,2-norbornanediamine]cobalt acetate, [N,N′-bis(5-trifluoromethyl-3-isopropylsalicylidene)-1,2-benzenediamine]cobalt acetate, [N,N′-bis(5-trifluoromethyl-3-isopropylsalicylidene)-1,3-benzenediamine]cobalt acetate, [N,N′-bis(5-trifluoromethyl-3-isopropylsalicylidene)-1,4-benzenediamine]cobalt acetate, [N,N′-bis(5-trifluoromethyl-3-isopropylsalicylidene)-4-methoxy-1,2-benzenediamine]cobalt acetate, [N,N′-bis(5-trifluoromethyl-3-isopropylsalicylidene)-2,3-naphthalenediamine]cobalt acetate, [N,N′-bis(5-trifluoromethyl-3-isopropylsalicylidene)-1,8-naphthalenediamine]cobalt acetate, [N,N′-bis(3-isopropyl-5-trimethylsilylsalicylidene)methane diamine]cobalt acetate, [N,N′-bis(3-isopropyl-5-trimethylsilylsalicylidene)-1,2-ethanediamine]cobalt acetate, [N,N′-bis(3-isopropyl-5-trimethylsilylsalicylidene)-1,3-propanediamine]cobalt acetate, [N,N′-bis(3-isopropyl-5-trimethylsilylsalicylidene)-1,2-cyclopentanediamine]cobalt acetate, [N,N′-bis(3-isopropyl-5-trimethylsilylsalicylidene)-1,3-cyclopentanediamine]cobalt acetate, [N,N′-bis(3-isopropyl-5-trimethylsilylsalicylidene)-1,2-cyclohexanediamine]cobalt acetate, [N,N′-bis(3-isopropyl-5-trimethylsilylsalicylidene)-1,3-cyclohexanediamine]cobalt acetate, [N,N′-bis(3-isopropyl-5-trimethylsilylsalicylidene)-1,4-cyclohexanediamine]cobalt acetate, [N,N′-bis(3-isopropyl-5-trimethylsilylsalicylidene)-1,2-norbornanediamine]cobalt acetate, [N,N′-bis(3-isopropyl-5-trimethylsilylsalicylidene)-1,2-benzenediamine]cobalt acetate, [N,N′-bis(3-isopropyl-5-trimethylsilylsalicylidene)-1,3-benzenediamine]cobalt acetate, [N,N′-bis(3-isopropyl-5-trimethylsilylsalicylidene)-1,4-benzenediamine]cobalt acetate, [N,N′-bis(3-isopropyl-5-trimethylsilylsalicylidene)-4-methoxy-1,2-benzenediamine]cobalt acetate, [N,N′-bis(3-isopropyl-5-trimethylsilylsalicylidene)-2,3-acetate, naphthalenediamine]cobalt [N,N′-bis(3-isopropyl-5-trimethylsilylsalicylidene)-1,8-naphthalenediamine]cobalt acetate, and compounds obtained by changing the term “acetate” contained in the above compounds to the term “propionate”, “n-butyrate”, “isobutyrate”, “n-pentyrate”, “isopentyrate”, “sec-pentyrate”, “tert-pentyrate”, “trifluoroacetate”, “benzoate”, “fluoride”, “chloride”, “bromide”, “iodide”, “methoxide”, “ethoxide”, “isopropoxide”, “tert-butoxide”, “phenoxide”, “pentafluorophenoxide”, “benzyloxide”, “dimethylamide”, “diethylamide”, “hydroxide”, or “cyanide”.

Moreover, examples of the cobalt complex represented by formula (3) are as follows: [N,N′-bis(3-tert-butyl-5-methylsalicylidene)methanediamine]cobalt acetate, [N,N′-bis(3-tert-butyl-5-methylsalicylidene)-1,2-ethane diamine]cobalt acetate, [N,N′-bis(3-tert-butyl-5-methylsalicylidene)-1,3-propane diamine]cobalt acetate, [N,N′-bis(3-tert-butyl-5-methylsalicylidene)-1,2-cyclopentanediamine]cobalt acetate, [N,N′-bis(3-tert-butyl-5-methylsalicylidene)-1,3-cyclopentanediamine]cobalt acetate, [N,N′-bis(3-tert-butyl-5-methylsalicylidene)-1,2-cyclohexanediamine]cobalt acetate, [N,N′-bis(3-tert-butyl-5-methylsalicylidene)-1,3-cyclohexanediamine]cobalt acetate, [N,N′-bis(3-tert-butyl-5-methylsalicylidene)-1,4-cyclohexanediamine]cobalt acetate, [N,N′-bis(3-tert-butyl-5-methylsalicylidene)-1,2-norbornane diamine]cobalt acetate, [N,N′-bis(3-tert-butyl-5-methylsalicylidene)-1,2-benzene diamine]cobalt acetate, [N,N′-bis(3-tert-butyl-5-methylsalicylidene)-1,3-benzene diamine]cobalt acetate, [N,N′-bis(3-tert-butyl-5-methylsalicylidene)-1,4-benzene diamine]cobalt acetate, [N,N′-bis(3-tert-butyl-5-methylsalicylidene)-4-methoxy-1,2-benzenediamine]cobalt acetate, [N,N′-bis(3-tert-butyl-5-methylsalicylidene)-2,3-naphthalenediamine]cobalt acetate, [N,N′-bis(3-tert-butyl-5-methylsalicylidene)-1,8-naphthalenediamine]cobalt acetate, [N,N′-bis(3-tert-butyl-5-ethylsalicylidene)methanediamine]cobalt acetate, [N,N′-bis(3-tert-butyl-5-ethylsalicylidene)-1,2-ethane diamine]cobalt acetate, [N,N′-bis(3-tert-butyl-5-ethylsalicylidene)-1,3-propane diamine]cobalt acetate, [N,N′-bis(3-tert-butyl-5-ethylsalicylidene)-1,2-cyclopentanediamine]cobalt acetate, [N,N′-bis(3-tert-butyl-5-ethylsalicylidene)-1,3-cyclopentanediamine]cobalt acetate, [N,N′-bis(3-tert-butyl-5-ethylsalicylidene)-1,2-cyclohexane diamine]cobalt acetate, [N,N′-bis(3-tert-butyl-5-ethylsalicylidene)-1,3-cyclohexane diamine]cobalt acetate, [N,N′-bis(3-tert-butyl-5-ethylsalicylidene)-1,4-cyclohexane diamine]cobalt acetate, [N,N′-bis(3-tert-butyl-5-ethylsalicylidene)-1,2-norbornane diamine]cobalt acetate, [N,N′-bis(3-tert-butyl-5-ethylsalicylidene)-1,2-benzene diamine]cobalt acetate, [N,N′-bis(3-tert-butyl-5-ethylsalicylidene)-1,3-benzene diamine]cobalt acetate, [N,N′-bis(3-tert-butyl-5-ethylsalicylidene)-1,4-benzene diamine]cobalt acetate, [N,N′-bis(3-tert-butyl-5-ethylsalicylidene)-4-methoxy-1,2-benzenediamine]cobalt acetate, [N,N′-bis(3-tert-butyl-5-ethylsalicylidene)-2,3-naphthalene diamine]cobalt acetate, [N,N′-bis(3-tert-butyl-5-ethylsalicylidene)-1,8-naphthalenediamine]cobalt acetate, [N,N′-bis(3-tert-butyl-5-n-propylsalicylidene)methane diamine]cobalt acetate, [N,N′-bis(3-tert-butyl-5-n-propylsalicylidene)-1,2-ethane diamine]cobalt acetate, [N,N′-bis(3-tert-butyl-5-n-propylsalicylidene)-1,3-propane diamine]cobalt acetate, [N,N′-bis(3-tert-butyl-5-n-propylsalicylidene)-1,2-cyclopentanediamine]cobalt acetate, [N,N′-bis(3-tert-butyl-5-n-propylsalicylidene)-1,3-cyclopentanediamine]cobalt acetate, [N,N′-bis(3-tert-butyl-5-n-propylsalicylidene)-1,2-cyclohexanediamine]cobalt acetate, [N,N′-bis(3-tert-butyl-5-n-propylsalicylidene)-1,3-cyclohexanediamine]cobalt acetate, [N,N′-bis(3-tert-butyl-5-n-propylsalicylidene)-1,4-cyclohexanediamine]cobalt acetate, [N,N′-bis(3-tert-butyl-5-n-propylsalicylidene)-1,2-norbornanediamine]cobalt acetate, [N,N′-bis(3-tert-butyl-5-n-propylsalicylidene)-1,2-benzene diamine]cobalt acetate, [N,N′-bis(3-tert-butyl-5-n-propylsalicylidene)-1,3-benzene diamine]cobalt acetate, [N,N′-bis(3-tert-butyl-5-n-propylsalicylidene)-1,4-benzene diamine]cobalt acetate, [N,N′-bis(3-tert-butyl-5-n-propylsalicylidene)-4-methoxy-1,2-benzenediamine]cobalt acetate, [N,N′-bis(3-tert-butyl-5-n-propylsalicylidene)-2,3-naphthalenediamine]cobalt acetate, [N,N′-bis(3-tert-butyl-5-n-propylsalicylidene)-1,8-naphthalenediamine]cobalt acetate, [N,N′-bis(3-tert-butyl-5-isopropylsalicylidene)methane diamine]cobalt acetate, [N,N′-bis(3-tert-butyl-5-isopropylsalicylidene)-1,2-ethane diamine]cobalt acetate, [N,N′-bis(3-tert-butyl-5-isopropylsalicylidene)-1,3-propane diamine]cobalt acetate, [N,N′-bis(3-tert-butyl-5-isopropylsalicylidene)-1,2-cyclopentanediamine]cobalt acetate, [N,N′-bis(3-tert-butyl-5-isopropylsalicylidene)-1,3-cyclopentanediamine]cobalt acetate, [N,N′-bis(3-tert-butyl-5-isopropylsalicylidene)-1,2-cyclohexanediamine]cobalt acetate, [N,N′-bis(3-tert-butyl-5-isopropylsalicylidene)-1,3-cyclohexanediamine]cobalt acetate, [N,N′-bis(3-tert-butyl-5-isopropylsalicylidene)-1,4-cyclohexanediamine]cobalt acetate, [N,N′-bis(3-tert-butyl-S-isopropylsalicylidene)-1,2-norbornanediamine]cobalt acetate, [N,N′-bis(3-tert-butyl-5-isopropylsalicylidene)-1,2-benzene diamine]cobalt acetate, [N,N′-bis(3-tert-butyl-5-isopropylsalicylidene)-1,3-benzene diamine]cobalt acetate, [N,N′-bis(3-tert-butyl-5-isopropylsalicylidene)-1,4-benzene diamine]cobalt acetate, [N,N′-bis(3-tert-butyl-5-isopropylsalicylidene)-4-methoxy-1,2-benzenediamine]cobalt acetate, [N,N′-bis(3-tert-butyl-5-isopropylsalicylidene)-2,3-naphthalenediamine]cobalt acetate, [N,N′-bis(3-tert-butyl-5-isopropylsalicylidene)-1,8-naphthalenediamine]cobalt acetate, [N,N′-bis(5-n-butyl-3-tert-butylsalicylidene)methane diamine]cobalt acetate, [N,N′-bis(5-n-butyl-3-tert-butylsalicylidene)-1,2-ethane diamine]cobalt acetate, [N,N′-bis(5-n-butyl-3-tert-butylsalicylidene)-1,3-propane diamine]cobalt acetate, [N,N′-bis(5-n-butyl-3-tert-butylsalicylidene)-1,2-cyclopentanediamine]cobalt acetate, [N,N′-bis(5-n-butyl-3-tert-butylsalicylidene)-1,3-cyclopentanediamine]cobalt acetate, [N,N′-bis(5-n-butyl-3-tert-butylsalicylidene)-1,2-cyclohexanediamine]cobalt acetate, [N,N′-bis(5-n-butyl-3-tert-butylsalicylidene)-1,3-cyclohexanediamine]cobalt acetate, [N,N′-bis(5-n-butyl-3-tert-butylsalicylidene)-1,4-cyclohexanediamine]cobalt acetate, [N,N′-bis(5-n-butyl-3-tert-butylsalicylidene)-1,2-norbornanediamine]cobalt acetate, [N,N′-bis(5-n-butyl-3-tert-butylsalicylidene)-1,2-benzenediamine]cobalt acetate, [N,N′-bis(5-n-butyl-3-tert-butylsalicylidene)-1,3-benzene diamine]cobalt acetate, [N,N′-bis(5-n-butyl-3-tert-butylsalicylidene)-1,4-benzene diamine]cobalt acetate, [N,N′-bis(5-n-butyl-3-tert-butylsalicylidene)-4-methoxy-1,2-benzenediamine]cobalt acetate, [N,N′-bis(5-n-butyl-3-tert-butylsalicylidene)-2,3-naphthalenediamine]cobalt acetate, [N,N′-bis(5-n-butyl-3-tert-butylsalicylidene)-1,8-naphthalenediamine]cobalt acetate, [N,N′-bis(5-isobutyl-3-tert-butylsalicylidene)methane diamine]cobalt acetate, [N,N′-bis(5-isobutyl-3-tert-butylsalicylidene)-1,2-ethane diamine]cobalt acetate, [N,N′-bis(5-isobutyl-3-tert-butylsalicylidene)-1,3-propane diamine]cobalt acetate, [N,N′-bis(5-isobutyl-3-tert-butylsalicylidene)-1,2-cyclopentanediamine]cobalt acetate, [N,N′-bis(5-isobutyl-3-tert-butylsalicylidene)-1,3-cyclopentanediamine]cobalt acetate, [N,N′-bis(5-isobutyl-3-tert-butylsalicylidene)-1,2-cyclohexanediamine]cobalt acetate, [N,N′-bis(5-isobutyl-3-tert-butylsalicylidene)-1,3-cyclohexanediamine]cobalt acetate, [N,N′-bis(5-isobutyl-3-tert-butylsalicylidene)-1,4-cyclohexanediamine]cobalt acetate, [N,N′-bis(5-isobutyl-3-tert-butylsalicylidene)-1,2-norbornanediamine]cobalt acetate, [N,N′-bis(5-isobutyl-3-tert-butylsalicylidene)-1,2-benzene diamine]cobalt acetate, [N,N′-bis(5-isobutyl-3-tert-butylsalicylidene)-1,3-benzene diamine]cobalt acetate, [N,N′-bis(5-isobutyl-3-tert-butylsalicylidene)-1,4-benzene diamine]cobalt acetate, [N,N′-bis(5-isobutyl-3-tert-butylsalicylidene)-4-methoxy-1,2-benzenediamine]cobalt acetate, [N,N′-bis(5-isobutyl-3-tert-butylsalicylidene)-2,3-naphthalenediamine]cobalt acetate, [N,N′-bis(5-isobutyl-3-tert-butylsalicylidene)-1,8-naphthalenediamine]cobalt acetate, [N,N′-bis(5-sec-butyl-3-tert-butylsalicylidene)methane diamine]cobalt acetate, [N,N′-bis(5-sec-butyl-3-tert-butylsalicylidene)-1,2-ethane diamine]cobalt acetate, [N,N′-bis(5-sec-butyl-3-tert-butylsalicylidene)-1,3-propane diamine]cobalt acetate, [N,N′-bis(5-sec-butyl-3-tert-butylsalicylidene)-1,2-cyclopentanediamine]cobalt acetate, [N,N′-bis(5-sec-butyl-3-tert-butylsalicylidene)-1,3-cyclopentanediamine]cobalt acetate, [N,N′-bis(5-sec-butyl-3-tert-butylsalicylidene)-1,2-cyclohexanediamine]cobalt acetate, [N,N′-bis(5-sec-butyl-3-tert-butylsalicylidene)-1,3-cyclohexanediamine]cobalt acetate, [N,N′-bis(5-sec-butyl-3-tert-butylsalicylidene)-1,4-cyclohexanediamine]cobalt acetate, [N,N′-bis(5-sec-butyl-3-tert-butylsalicylidene)-1,2-norbornanediamine]cobalt acetate, [N,N′-bis(5-sec-butyl-3-tert-butylsalicylidene)-1,2-benzene diamine]cobalt acetate, [N,N′-bis(5-sec-butyl-3-tert-butylsalicylidene)-1,3-benzene diamine]cobalt acetate, [N,N′-bis(5-sec-butyl-3-tert-butylsalicylidene)-1,4-benzene diamine]cobalt acetate, [N,N′-bis(5-sec-butyl-3-tert-butylsalicylidene)-4-methoxy-1,2-benzenediamine]cobalt acetate, [N,N′-bis(5-sec-butyl-3-tert-butylsalicylidene)-2,3-naphthalenediamine]cobalt acetate, [N,N′-bis(5-sec-butyl-3-tert-butylsalicylidene)-1,8-naphthalenediamine]cobalt acetate, [N,N′-bis(3-tert-butyl-5-neopentylsalicylidene)methane diamine]cobalt acetate, [N,N′-bis(3-tert-butyl-5-neopentylsalicylidene)-1,2-ethane diamine]cobalt acetate, [N,N′-bis(3-tert-butyl-5-neopentylsalicylidene)-1,3-propane diamine]cobalt acetate, [N,N′-bis(3-tert-butyl-5-neopentylsalicylidene)-1,2-cyclopentanediamine]cobalt acetate, [N,N′-bis(3-tert-butyl-5-neopentylsalicylidene)-1,3-cyclopentanediamine]cobalt acetate, [N,N′-bis(3-tert-butyl-5-neopentylsalicylidene)-1,2-cyclohexanediamine]cobalt acetate, [N,N′-bis(3-tert-butyl-5-neopentylsalicylidene)-1,3-cyclohexanediamine]cobalt acetate, [N,N′-bis(3-tert-butyl-5-neopentylsalicylidene)-1,4-cyclohexanediamine]cobalt acetate, [N,N′-bis(3-tert-butyl-5-neopentylsalicylidene)-1,2-norbornanediamine]cobalt acetate, [N,N′-bis(3-tert-butyl-5-neopentylsalicylidene)-1,2-benzene diamine]cobalt acetate, [N,N′-bis(3-tert-butyl-5-neopentylsalicylidene)-1,3-benzene diamine]cobalt acetate, [N,N′-bis(3-tert-butyl-5-neopentylsalicylidene)-1,4-benzene diamine]cobalt acetate, [N,N′-bis(3-tert-butyl-5-neopentylsalicylidene)-4-methoxy-1,2-benzenediamine]cobalt acetate, [N,N′-bis(3-tert-butyl-5-neopentylsalicylidene)-2,3-naphthalenediamine]cobalt acetate, [N,N′-bis(3-tert-butyl-5-neopentylsalicylidene)-1,8-naphthalenediamine]cobalt acetate, [N,N′-bis(5-isoamyl-3-tert-butylsalicylidene)methane diamine]cobalt acetate, [N,N′-bis(5-isoamyl-3-tert-butylsalicylidene)-1,2-ethane diamine]cobalt acetate, [N,N′-bis(5-isoamyl-3-tert-butylsalicylidene)-1,3-propane diamine]cobalt acetate, [N,N′-bis(5-isoamyl-3-tert-butylsalicylidene)-1,2-cyclopentanediamine]cobalt acetate, [N,N′-bis(5-isoamyl-3-tert-butylsalicylidene)-1,3-cyclopentanediamine]cobalt acetate, [N,N′-bis(5-isoamyl-3-tert-butylsalicylidene)-1,2-cyclohexanediamine]cobalt acetate, [N,N′-bis(5-isoamyl-3-tert-butylsalicylidene)-1,3-cyclohexanediamine]cobalt acetate, [N,N′-bis(5-isoamyl-3-tert-butylsalicylidene)-1,4-cyclohexanediamine]cobalt acetate, [N,N′-bis(5-isoamyl-3-tert-butylsalicylidene)-1,2-norbornanediamine]cobalt acetate, [N,N′-bis(5-isoamyl-3-tert-butylsalicylidene)-1,2-benzene diamine]cobalt acetate, [N,N′-bis(5-isoamyl-3-tert-butylsalicylidene)-1,3-benzene diamine]cobalt acetate, [N,N′-bis(5-isoamyl-3-tert-butylsalicylidene)-1,4-benzene diamine]cobalt acetate, [N,N′-bis(5-isoamyl-3-tert-butylsalicylidene)-4-methoxy-1,2-benzenediamine]cobalt acetate, [N,N′-bis(5-isoamyl-3-tert-butylsalicylidene)-2,3-naphthalenediamine]cobalt acetate, [N,N′-bis(5-isoamyl-3-tert-butylsalicylidene)-1,8-naphthalenediamine]cobalt acetate, [N,N′-bis(3-tert-butyl-5-phenylsalicylidene)methanediamine]cobalt acetate, [N,N′-bis(3-tert-butyl-5-phenylsalicylidene)-1,2-ethane diamine]cobalt acetate, [N,N′-bis(3-tert-butyl-5-phenylsalicylidene)-1,3-propane diamine]cobalt acetate, [N,N′-bis(3-tert-butyl-5-phenylsalicylidene)-1,2-cyclopentanediamine]cobalt acetate, [N,N′-bis(3-tert-butyl-5-phenylsalicylidene)-1,3-cyclopentanediamine]cobalt acetate, [N,N′-bis(3-tert-butyl-5-phenylsalicylidene)-1,2-cyclohexanediamine]cobalt acetate, [N,N′-bis(3-tert-butyl-5-phenylsalicylidene)-1,3-cyclohexanediamine]cobalt acetate, [N,N′-bis(3-tert-butyl-5-phenylsalicylidene)-1,4-cyclohexanediamine]cobalt acetate, [N,N′-bis(3-tert-butyl-5-phenylsalicylidene)-1,2-norbornanediamine]cobalt acetate, [N,N′-bis(3-tert-butyl-5-phenylsalicylidene)-1,2-benzene diamine]cobalt acetate, [N,N′-bis(3-tert-butyl-5-phenylsalicylidene)-1,3-benzene diamine]cobalt acetate, [N,N′-bis(3-tert-butyl-5-phenylsalicylidene)-1,4-benzene diamine]cobalt acetate, [N,N′-bis(3-tert-butyl-5-phenylsalicylidene)-4-methoxy-1,2-benzenediamine]cobalt acetate, [N,N′-bis(3-tert-butyl-5-phenylsalicylidene)-2,3-naphthalenediamine]cobalt acetate, [N,N′-bis(3-tert-butyl-5-phenylsalicylidene)-1,8-naphthalenediamine]cobalt acetate, [N,N′-bis(3-tert-butyl-5-trifluoromethylsalicylidene)methanediamine]cobalt acetate, [N,N′-bis(3-tert-butyl-5-trifluoromethylsalicylidene)-1,2-ethanediamine]cobalt acetate, [N,N′-bis(3-tert-butyl-5-trifluoromethylsalicylidene)-1,3-propanediamine]cobalt acetate, [N,N′-bis(3-tert-butyl-5-trifluoromethylsalicylidene)-1,2-cyclopentanediamine]cobalt acetate, [N,N′-bis(3-tert-butyl-5-trifluoromethylsalicylidene)-1,3-cyclopentanediamine]cobalt acetate, [N,N′-bis(3-tert-butyl-5-trifluoromethylsalicylidene)-1,2-cyclohexanediamine]cobalt acetate, [N,N′-bis(3-tert-butyl-5-trifluoromethylsalicylidene)-1,3-cyclohexanediamine]cobalt acetate, [N,N′-bis(3-tert-butyl-5-trifluoromethylsalicylidene)-1,4-cyclohexanediamine]cobalt acetate, [N,N′-bis(3-tert-butyl-5-trifluoromethylsalicylidene)-1,2-norbornanediamine]cobalt acetate, [N,N′-bis(3-tert-butyl-5-trifluoromethylsalicylidene)-1,2-benzenediamine]cobalt acetate, [N,N′-bis(3-tert-butyl-5-trifluoromethylsalicylidene)-1,3-benzenediamine]cobalt acetate, [N,N′-bis(3-tert-butyl-5-trifluoromethylsalicylidene)-1,4-benzenediamine]cobalt acetate, [N,N′-bis(3-tert-butyl-5-trifluoromethylsalicylidene)-4-methoxy-1,2-benzenediamine]cobalt acetate, [N,N′-bis(3-tert-butyl-5-trifluoromethylsalicylidene)-2,3-naphthalenediamine]cobalt acetate, [N,N′-bis(3-tert-butyl-5-trifluoromethylsalicylidene)-1,8-naphthalenediamine]cobalt acetate, [N,N′-bis(3-tert-butyl-5-trimethylsilylsalicylidene)methane diamine]cobalt acetate, [N,N′-bis(3-tert-butyl-5-trimethylsilylsalicylidene)-1,2-ethanediamine]cobalt acetate, [N,N′-bis(3-tert-butyl-5-trimethylsilylsalicylidene)-1,3-propanediamine]cobalt acetate, [N,N′-bis(3-tert-butyl-5-trimethylsilylsalicylidene)-1,2-cyclopentanediamine]cobalt acetate, [N,N′-bis(3-tert-butyl-5-trimethylsilylsalicylidene)-1,3-cyclopentanediamine]cobalt acetate, [N,N′-bis(3-tert-butyl-5-trimethylsilylsalicylidene)-1,2-cyclohexanediamine]cobalt acetate, [N,N′-bis(3-tert-butyl-5-trimethylsilylsalicylidene)-1,3-cyclohexanediamine]cobalt acetate, [N,N′-bis(3-tert-butyl-5-trimethylsilylsalicylidene)-1,4-cyclohexanediamine]cobalt acetate, [N,N′-bis(3-tert-butyl-5-trimethylsilylsalicylidene)-1,2-norbornanediamine]cobalt acetate, [N,N′-bis(3-tert-butyl-5-trimethylsilylsalicylidene)-1,2-benzenediamine]cobalt acetate, [N,N′-bis(3-tert-butyl-5-trimethylsilylsalicylidene)-1,3-benzenediamine]cobalt acetate, [N,N′-bis(3-tert-butyl-5-trimethylsilylsalicylidene)-1,4-benzenediamine]cobalt acetate, [N,N′-bis(3-tert-butyl-5-trimethylsilylsalicylidene)-4-methoxy-1,2-benzenediamine]cobalt acetate, [N,N′-bis(3-tert-butyl-5-trimethylsilylsalicylidene)-2,3-naphthalenediamine]cobalt acetate, [N,N′-bis(3-tert-butyl-5-trimethylsilylsalicylidene)-1,8-naphthalenediamine]cobalt acetate, and compounds obtained by changing the term “acetate” contained in the above compounds to the term “propionate”, “n-butyrate”, “isobutyrate”, “n-pentyrate”, “isopentyrate”, “sec-pentyrate”, “tert-pentyrate”, “trifluoroacetate”, “benzoate”, “fluoride”, “chloride”, “bromide”, “iodide”, “methoxide”, “ethoxide”, “isopropoxide”, “tert-butoxide”, “phenoxide”, “pentafluorophenoxide”, “benzyloxide”, “dimethylamide”, “diethylamide”, “hydroxide”, or “cyanide”.

Furthermore, examples of the cobalt complex represented by formula (3) are as follows: [N,N′-bis(3,5-dimethylsalicylidene)methanediamine]cobalt acetate, [N,N′-bis(3,5-dimethylsalicylidene)-1,2-ethanediamine]cobalt acetate, [N,N′-bis(3,5-dimethylsalicylidene)-1,3-propanediamine]cobalt acetate, [N,N′-bis(3,5-dimethylsalicylidene)-1,2-cyclopentane acetate, diamine]cobalt [N,N′-bis(3,5-dimethylsalicylidene)-1,3-cyclopentane diamine]cobalt acetate, [N,N′-bis(3,5-dimethylsalicylidene)-1,2-cyclohexanediamine]cobalt acetate, [N,N′-bis(3,5-dimethylsalicylidene)-1,3-cyclohexanediamine]cobalt acetate, [N,N′-bis(3,5-dimethylsalicylidene)-1,4-cyclohexanediamine]cobalt acetate, [N,N′-bis(3,5-dimethylsalicylidene)-1,2-norbornanediamine]cobalt acetate, [N,N′-bis(3,5-dimethylsalicylidene)-1,2-benzenediamine]cobalt acetate, [N,N′-bis(3,5-dimethylsalicylidene)-1,3-benzenediamine]cobalt acetate, [N,N′-bis(3,5-dimethylsalicylidene)-1,4-benzenediamine]cobalt acetate, [N,N′-bis(3,5-dimethylsalicylidene)-4-methoxy-1,2-benzene diamine]cobalt acetate, [N,N′-bis(3,5-dimethylsalicylidene)-2,3-naphthalenediamine]cobalt acetate, [N,N′-bis(3,5-dimethylsalicylidene)-1,8-naphthalenediamine]cobalt acetate, [N,N′-bis(3,5-diethylsalicylidene)methanediamine]cobalt acetate, [N,N′-bis(3,5-diethylsalicylidene)-1,2-ethanediamine]cobalt acetate, [N,N′-bis(3,5-diethylsalicylidene)-1,3-propanediamine]cobalt acetate, [N,N′-bis(3,5-diethylsalicylidene)-1,2-cyclopentanediamine]cobalt acetate, [N,N′-bis(3,5-diethylsalicylidene)-1,3-cyclopentanediamine]cobalt acetate, [N,N′-bis(3,5-diethylsalicylidene)-1,2-cyclohexanediamine]cobalt acetate, [N,N′-bis(3,5-diethylsalicylidene)-1,3-cyclohexanediamine]cobalt acetate, [N,N′-bis(3,5-diethylsalicylidene)-1,4-cyclohexanediamine]cobalt acetate, [N,N′-bis(3,5-diethylsalicylidene)-1,2-norbornanediamine]cobalt acetate, [N,N′-bis(3,5-diethylsalicylidene)-1,2-benzenediamine]cobalt acetate, [N,N′-bis(3,5-diethylsalicylidene)-1,3-benzenediamine]cobalt acetate, [N,N′-bis(3,5-diethylsalicylidene)-1,4-benzenediamine]cobalt acetate, [N,N′-bis(3,5-diethylsalicylidene)-4-methoxy-1,2-benzene diamine]cobalt acetate, [N,N′-bis(3,5-diethylsalicylidene)-2,3-naphthalenediamine]cobalt acetate, [N,N′-bis(3,5-diethylsalicylidene)-1,8-naphthalenediamine]cobalt acetate, [N,N′-bis(3,5-di-n-propylsalicylidene)methanediamine]cobalt acetate, [N,N′-bis(3,5-di-n-propylsalicylidene)-1,2-ethanediamine]cobalt acetate, [N,N′-bis(3,5-di-n-propylsalicylidene)-1,3-propanediamine]cobalt acetate, [N,N′-bis(3,5-di-n-propylsalicylidene)-1,2-cyclopentane diamine]cobalt acetate, [N,N′-bis(3,5-di-n-propylsalicylidene)-1,3-cyclopentane diamine]cobalt acetate, [N,N′-bis(3,5-di-n-propylsalicylidene)-1,2-cyclohexane diamine]cobalt acetate, [N,N′-bis(3,5-di-n-propylsalicylidene)-1,3-cyclohexane diamine]cobalt acetate, [N,N′-bis(3,5-di-n-propylsalicylidene)-1,4-cyclohexane diamine]cobalt acetate, [N,N′-bis(3,5-di-n-propylsalicylidene)-1,2-norbornane diamine]cobalt acetate, [N,N′-bis(3,5-di-n-propylsalicylidene)-1,2-benzenediamine]cobalt acetate, [N,N′-bis(3,5-di-n-propylsalicylidene)-1,3-benzenediamine]cobalt acetate, [N,N′-bis(3,5-di-n-propylsalicylidene)-1,4-benzenediamine]cobalt acetate, [N,N′-bis(3,5-di-n-propylsalicylidene)-4-methoxy-1,2-benzenediamine]cobalt acetate, [N,N′-bis(3,5-di-n-propylsalicylidene)-2,3-naphthalene diamine]cobalt acetate, [N,N′-bis(3,5-di-n-propylsalicylidene)-1,8-naphthalenediamine]cobalt acetate, [N,N′-bis(3,5-diisopropylsalicylidene)methanediamine]cobalt acetate, [N,N′-bis(3,5-diisopropylsalicylidene)-1,2-ethanediamine]cobalt acetate, [N,N′-bis(3,5-diisopropylsalicylidene)-1,3-propanediamine]cobalt acetate, [N,N′-bis(3,5-diisopropylsalicylidene)-1,2-cyclopentane diamine]cobalt acetate, [N,N′-bis(3,5-diisopropylsalicylidene)-1,3-cyclopentane diamine]cobalt acetate, [N,N′-bis(3,5-diisopropylsalicylidene)-1,2-cyclohexane diamine]cobalt acetate, [N,N′-bis(3,5-diisopropylsalicylidene)-1,3-cyclohexane diamine]cobalt acetate, [N,N′-bis(3,5-diisopropylsalicylidene)-1,4-cyclohexane diamine]cobalt acetate, [N,N′-bis(3,5-diisopropylsalicylidene)-1,2-norbornane diamine]cobalt acetate, [N,N′-bis(3,5-diisopropylsalicylidene)-1,2-benzenediamine]cobalt acetate, [N,N′-bis(3,5-diisopropylsalicylidene)-1,3-benzenediamine]cobalt acetate, [N,N′-bis(3,5-diisopropylsalicylidene)-1,4-benzenediamine]cobalt acetate, [N,N′-bis(3,5-diisopropylsalicylidene)-4-methoxy-1,2-benzenediamine]cobalt acetate, [N,N′-bis(3,5-diisopropylsalicylidene)-2,3-naphthalene diamine]cobalt acetate, [N,N′-bis(3,5-diisopropylsalicylidene)-1,8-naphthalenediamine]cobalt acetate, [N,N′-bis(3,5-di-n-butylsalicylidene)methanediamine]cobalt acetate, [N,N′-bis(3,5-di-n-butylsalicylidene)-1,2-ethanediamine]cobalt acetate, [N,N′-bis(3,5-di-n-butylsalicylidene)-1,3-propanediamine]cobalt acetate, [N,N′-bis(3,5-di-n-butylsalicylidene)-1,2-cyclopentane diamine]cobalt acetate, [N,N′-bis(3,5-di-n-butylsalicylidene)-1,3-cyclopentane diamine]cobalt acetate, [N,N′-bis(3,5-di-n-butylsalicylidene)-1,2-cyclohexane diamine]cobalt acetate, [N,N′-bis(3,5-di-n-butylsalicylidene)-1,3-cyclohexane diamine]cobalt acetate, [N,N′-bis(3,5-di-n-butylsalicylidene)-1,4-cyclohexane diamine]cobalt acetate, [N,N′-bis(3,5-di-n-butylsalicylidene)-1,2-norbornane diamine]cobalt acetate, [N,N′-bis(3,5-di-n-butylsalicylidene)-1,2-benzenediamine]cobalt acetate, [N,N′-bis(3,5-di-n-butylsalicylidene)-1,3-benzenediamine]cobalt acetate, [N,N′-bis(3,5-di-n-butylsalicylidene)-1,4-benzenediamine]cobalt acetate, [N,N′-bis(3,5-di-n-butylsalicylidene)-4-methoxy-1,2-benzenediamine]cobalt acetate, [N,N′-bis(3,5-di-n-butylsalicylidene)-2,3-naphthalene diamine]cobalt acetate, [N,N′-bis(3,5-di-n-butylsalicylidene)-1,8-naphthalenediamine]cobalt acetate, [N,N′-bis(3,5-diisobutylsalicylidene)methanediamine]cobalt acetate, [N,N′-bis(3,5-diisobutylsalicylidene)-1,2-ethanediamine]cobalt acetate, [N,N′-bis(3,5-diisobutylsalicylidene)-1,3-propanediamine]cobalt acetate, [N,N′-bis(3,5-diisobutylsalicylidene)-1,2-cyclopentane diamine]cobalt acetate, [N,N′-bis(3,5-diisobutylsalicylidene)-1,3-cyclopentane diamine]cobalt acetate, [N,N′-bis(3,5-diisobutylsalicylidene)-1,2-cyclohexane diamine]cobalt acetate, [N,N′-bis(3,5-diisobutylsalicylidene)-1,3-cyclohexane diamine]cobalt acetate, [N,N′-bis(3,5-diisobutylsalicylidene)-1,4-cyclohexane diamine]cobalt acetate, [N,N′-bis(3,5-diisobutylsalicylidene)-1,2-norbornane diamine]cobalt acetate, [N,N′-bis(3,5-diisobutylsalicylidene)-1,2-benzenediamine]cobalt acetate, [N,N′-bis(3,5-diisobutylsalicylidene)-1,3-benzenediamine]cobalt acetate, [N,N′-bis(3,5-diisobutylsalicylidene)-1,4-benzenediamine]cobalt acetate, [N,N′-bis(3,5-diisobutylsalicylidene)-4-methoxy-1,2-benzene diamine]cobalt acetate, [N,N′-bis(3,5-diisobutylsalicylidene)-2,3-naphthalene diamine]cobalt acetate, [N,N′-bis(3,5-diisobutylsalicylidene)-1,8-naphthalenediamine]cobalt acetate, [N,N′-bis(3,5-di-sec-butylsalicylidene)methanediamine]cobalt acetate, [N,N′-bis(3,5-di-sec-butylsalicylidene)-1,2-ethanediamine]cobalt acetate, [N,N′-bis(3,5-di-sec-butylsalicylidene)-1,3-propanediamine]cobalt acetate, [N,N′-bis(3,5-di-sec-butylsalicylidene)-1,2-cyclopentane diamine]cobalt acetate, [N,N′-bis(3,5-di-sec-butylsalicylidene)-1,3-cyclopentane diamine]cobalt acetate, [N,N′-bis(3,5-di-sec-butylsalicylidene)-1,2-cyclohexane acetate, diamine]cobalt [N,N′-bis(3,5-di-sec-butylsalicylidene)-1,3-cyclohexane diamine]cobalt acetate, [N,N′-bis(3,5-di-sec-butylsalicylidene)-1,4-cyclohexane diamine]cobalt acetate, [N,N′-bis(3,5-di-sec-butylsalicylidene)-1,2-norbornane diamine]cobalt acetate, [N,N′-bis(3,5-di-sec-butylsalicylidene)-1,2-benzenediamine]cobalt acetate, [N,N′-bis(3,5-di-sec-butylsalicylidene)-1,3-benzenediamine]cobalt acetate, [N,N′-bis(3,5-di-sec-butylsalicylidene)-1,4-benzenediamine]cobalt acetate, [N,N′-bis(3,5-di-sec-butylsalicylidene)-4-methoxy-1,2-benzenediamine]cobalt acetate, [N,N′-bis(3,5-di-sec-butylsalicylidene)-2,3-naphthalene diamine]cobalt acetate, [N,N′-bis(3,5-di-sec-butylsalicylidene)-1,8-naphthalenediamine]cobalt acetate, [N,N′-bis(3,5-di-tert-butylsalicylidene)methanediamine]cobalt acetate, [N,N′-bis(3,5-di-tert-butylsalicylidene)-1,2-ethanediamine]cobalt acetate, [N,N′-bis(3,5-di-tert-butylsalicylidene)-1,3-propane diamine]cobalt acetate, [N,N′-bis(3,5-di-tert-butylsalicylidene)-1,2-cyclopentane diamine]cobalt acetate, [N,N′-bis(3,5-di-tert-butylsalicylidene)-1,3-cyclopentane diamine]cobalt acetate, [N,N′-bis(3,5-di-tert-butylsalicylidene)-1,2-cyclohexane diamine]cobalt acetate, [N,N′-bis(3,5-di-tert-butylsalicylidene)-1,3-cyclohexane diamine]cobalt acetate, [N,N′-bis(3,5-di-tert-butylsalicylidene)-1,4-cyclohexane diamine]cobalt acetate, [N,N′-bis(3,5-di-tert-butylsalicylidene)-1,2-norbornane diamine]cobalt acetate, [N,N′-bis(3,5-di-tert-butylsalicylidene)-1,2-benzene diamine]cobalt acetate, [N,N′-bis(3,5-di-tert-butylsalicylidene)-1,3-benzene diamine]cobalt acetate, [N,N′-bis(3,5-di-tert-butylsalicylidene)-1,4-benzene diamine]cobalt acetate, [N,N′-bis(3,5-di-tert-butylsalicylidene)-4-methoxy-1,2-benzenediamine]cobalt acetate, [N,N′-bis(3,5-di-tert-butylsalicylidene)-2,3-naphthalene diamine]cobalt acetate, [N,N′-bis(3,5-di-tert-butylsalicylidene)-1,8-naphthalenediamine]cobalt acetate, [N,N′-bis(3,5-dineopentylsalicylidene)methanediamine]cobalt acetate, [N,N′-bis(3,5-dineopentylsalicylidene)-1,2-ethanediamine]cobalt acetate, [N,N′-bis(3,5-dineopentylsalicylidene)-1,3-propanediamine]cobalt acetate, [N,N′-bis(3,5-dineopentylsalicylidene)-1,2-cyclopentane diamine]cobalt acetate, [N,N′-bis(3,5-dineopentylsalicylidene)-1,3-cyclopentane diamine]cobalt acetate, [N,N′-bis(3,5-dineopentylsalicylidene)-1,2-cyclohexane diamine]cobalt acetate, [N,N′-bis(3,5-dineopentylsalicylidene)-1,3-cyclohexane diamine]cobalt acetate, [N,N′-bis(3,5-dineopentylsalicylidene)-1,4-cyclohexane diamine]cobalt acetate, [N,N′-bis(3,5-dineopentylsalicylidene)-1,2-norbornane diamine]cobalt acetate, [N,N′-bis(3,5-dineopentylsalicylidene)-1,2-benzenediamine]cobalt acetate, [N,N′-bis(3,5-dineopentylsalicylidene)-1,3-benzenediamine]cobalt acetate, [N,N′-bis(3,5-dineopentylsalicylidene)-1,4-benzenediamine]cobalt acetate, [N,N′-bis(3,5-dineopentylsalicylidene)-4-methoxy-1,2-benzenediamine]cobalt acetate, [N,N′-bis(3,5-dineopentylsalicylidene)-2,3-naphthalene diamine]cobalt acetate, [N,N′-bis(3,5-dineopentylsalicylidene)-1,8-naphthalenediamine]cobalt acetate, [N,N′-bis(3,5-diisoamylsalicylidene)methanediamine]cobalt acetate, [N,N′-bis(3,5-diisoamylsalicylidene)-1,2-ethanediamine]cobalt acetate, [N,N′-bis(3,5-diisoamylsalicylidene)-1,3-propanediamine]cobalt acetate, [N, Nf-bis(3,5-diisoamylsalicylidene)-1,2-cyclopentane diamine]cobalt acetate, [N,N′-bis(3,5-diisoamylsalicylidene)-1,3-cyclopentane diamine]cobalt acetate, [N,N′-bis(3,5-diisoamylsalicylidene)-1,2-cyclohexane diamine]cobalt acetate, [N,N′-bis(3,5-diisoamylsalicylidene)-1,3-cyclohexane diamine]cobalt acetate, [N,N′-bis(3,5-diisoamylsalicylidene)-1,4-cyclohexane diamine]cobalt acetate, [N,N′-bis(3,5-diisoamylsalicylidene)-1,2-norbornanediamine]cobalt acetate, [N,N′-bis(3,5-diisoamylsalicylidene)-1,2-benzenediamine]cobalt acetate, [N,N′-bis(3,5-diisoamylsalicylidene)-1,3-benzenediamine]cobalt acetate, [N,N′-bis(3,5-diisoamylsalicylidene)-1,4-benzenediamine]cobalt acetate, [N,N′-bis(3,5-diisoamylsalicylidene)-4-methoxy-1,2-benzene acetate, diamine]cobalt [N,N′-bis(3,5-diisoamylsalicylidene)-2,3-naphthalene diamine]cobalt acetate, [N,N′-bis(3,5-diisoamylsalicylidene)-1,8-naphthalenediamine]cobalt acetate, [N,N′-bis(3,5-diphenylsalicylidene)methanediamine]cobalt acetate, [N,N′-bis(3,5-diphenylsalicylidene)-1,2-ethanediamine]cobalt acetate, [N,N′-bis(3,5-diphenylsalicylidene)-1,3-propanediamine]cobalt acetate, [N,N′-bis(3,5-diphenylsalicylidene)-1,2-cyclopentane diamine]cobalt acetate, [N,N′-bis(3,5-diphenylsalicylidene)-1,3-cyclopentane diamine]cobalt acetate, [N,N′-bis(3,5-diphenylsalicylidene)-1,2-cyclohexanediamine]cobalt acetate, [N,N′-bis(3,5-diphenylsalicylidene)-1,3-cyclohexanediamine]cobalt acetate, [N,N′-bis(3,5-diphenylsalicylidene)-1,4-cyclohexanediamine]cobalt acetate, [N,N′-bis(3,5-diphenylsalicylidene)-1,2-norbornanediamine]cobalt acetate, [N,N′-bis(3,5-diphenylsalicylidene)-1,2-benzenediamine]cobalt acetate, [N,N′-bis(3,5-diphenylsalicylidene)-1,3-benzenediamine]cobalt acetate, [N,N′-bis(3,5-diphenylsalicylidene)-1,4-benzenediamine]cobalt acetate, [N,N′-bis(3,5-diphenylsalicylidene)-4-methoxy-1,2-benzene diamine]cobalt acetate, [N,N′-bis(3,5-diphenylsalicylidene)-2,3-naphthalenediamine]cobalt acetate, [N,N′-bis(3,5-diphenylsalicylidene)-1,8-naphthalenediamine]cobalt acetate, [N,N′-bis-{3,5-bis(trifluoromethyl)salicylidene}methane diamine]cobalt acetate, [N,N′-bis-{3,5-bis(trifluoromethyl)salicylidene}-1,2-ethane diamine]cobalt acetate, [N,N′-bis-{3,5-bis(trifluoromethyl)salicylidene}-1,3-propanediamine]cobalt acetate, [N,N′-bis-{3,5-bis(trifluoromethyl)salicylidene}-1,2-cyclopentanediamine]cobalt acetate, [N,N′-bis-{3,5-bis(trifluoromethyl)salicylidene}-1,3-cyclopentanediamine]cobalt acetate, [N,N′-bis-{3,5-bis(trifluoromethyl)salicylidene}-1,2-cyclohexanediamine]cobalt acetate, [N,N′-bis-{3,5-bis(trifluoromethyl)salicylidene}-1,3-cyclohexanediamine]cobalt acetate, [N,N′-bis-{3,5-bis(trifluoromethyl)salicylidene}-1,4-cyclohexanediamine]cobalt acetate, [N,N′-bis-{3,5-bis(trifluoromethyl)salicylidene}-1,2-norbornanediamine]cobalt acetate, [N,N′-bis-{3,5-bis(trifluoromethyl)salicylidene}-1,2-benzenediamine]cobalt acetate, [N,N′-bis-{3,5-bis(trifluoromethyl)salicylidene}-1,3-benzenediamine]cobalt acetate, [N,N′-bis-{3,5-bis(trifluoromethyl)salicylidene}-1,4-benzenediamine]cobalt acetate, [N,N′-bis-{3,5-bis(trifluoromethyl)salicylidene}-4-methoxy-1,2-benzenediamine]cobalt acetate, [N,N′-bis-{3,5-bis(trifluoromethyl)salicylidene}-2,3-naphthalenediamine]cobalt acetate, [N,N′-bis-{3,5-bis(trifluoromethyl)salicylidene}-1,8-naphthalenediamine]cobalt acetate, [N,N′-bis-{3,5-bis(trimethylsilyl)salicylidene}methane diamine]cobalt acetate, [N,N′-bis-{3,5-bis(trimethylsilyl)salicylidene}-1,2-ethane diamine]cobalt acetate, [N,N′-bis-{3,5-bis(trimethylsilyl)salicylidene}-1,3-propane diamine]cobalt acetate, [N,N′-bis-{3,5-bis(trimethylsilyl)salicylidene}-1,2-cyclopentanediamine]cobalt acetate, [N,N′-bis-{3,5-bis(trimethylsilyl)salicylidene}-1,3-cyclopentanediamine]cobalt acetate, [N,N′-bis-{3,5-bis(trimethylsilyl)salicylidene}-1,2-cyclohexanediamine]cobalt acetate, [N,N′-bis-{3,5-bis(trimethylsilyl)salicylidene}-1,3-cyclohexanediamine]cobalt acetate, [N,N′-bis-{3,5-bis(trimethylsilyl)salicylidene}-1,4-cyclohexanediamine]cobalt acetate, [N,N′-bis-{3,5-bis(trimethylsilyl)salicylidene}-1,2-norbornanediamine]cobalt acetate, [N,N′-bis-{3,5-bis(trimethylsilyl)salicylidene}-1,2-benzene diamine]cobalt acetate, [N,N′-bis-{3,5-bis(trimethylsilyl)salicylidene}-1,3-benzene diamine]cobalt acetate, [N,N′-bis-{3,5-bis(trimethylsilyl)salicylidene}-1,4-benzene diamine]cobalt acetate, [N,N′-bis-{3,5-bis(trimethylsilyl)salicylidene}-4-methoxy-1,2-benzenediamine]cobalt acetate, [N,N′-bis-{3,5-bis(trimethylsilyl)salicylidene}-2,3-naphthalenediamine]cobalt acetate, [N,N′-bis-{3,5-bis(trimethylsilyl)salicylidene}-1,8-naphthalenediamine]cobalt acetate, and compounds obtained by changing the term “acetate” contained in the above compounds to the term “propionate”, “n-butyrate”, “isobutyrate”, “n-pentyrate”, “isopentyrate”, “sec-pentyrate”, “tert-pentyrate”, “trifluoroacetate”, “benzoate”, “fluoride”, “chloride”, “bromide”, “iodide”, “methoxide”, “ethoxide”, “isopropoxide”, “tert-butoxide”, “phenoxide”, “pentafluorophenoxide”, “benzyloxide”, “dimethylamide”, “diethylamide”, “hydroxide”, or “cyanide”.

Examples of a method for producing the cobalt complex represented by formula (3) are (a) a method disclosed in “Chemistry—A European Journal, Vol. 5, No. 5, pages 1,460-1467 (May 3, 1999)” edited by WILEY-VCH Verlag GmbH & Co. KGaA, Weinheim, and (b) a method disclosed in “Journal of American Chemical Society, Vol. 127, No. 33, pages 11,566-11,567, (Jul. 26, 2005)” edited by American Chemical Society, provided that, in methods (a) and (b), E in formula (3) is a 1,2-benzenediyl group, R¹ and R³ therein are a tert-butyl group, R², R⁴ and R⁵ therein area hydrogen atom, and X therein is an acetoxy group.

The aliphatic compound and/or alicyclic compound in the process of the present invention are used as a solvent when polymerizing the epoxide represented by formula (2). In order to obtain a high-molecular-weight isotactic poly(alkylene oxide), it is not preferable to use other compound than these compounds as a solvent. The aliphatic compound is preferably a paraffinic hydrocarbon such as n-hexane, n-heptane, n-octane, and a combination thereof. Among them, preferred is n-hexane or n-heptane. The alicyclic compound is preferably a cycloparaffinic hydrocarbon such as cyclohexane, cycloheptane, and a combination thereof. Among them, preferred is cyclohexane. These compounds are used in an amount of generally 1 to 200 parts by weight, and preferably 5 to 30 parts by weight, per one part by weight of the epoxide represented by formula (2), provided that the above amount is the total of the aliphatic compound and the alicyclic compound in case that a combination of these compounds is used.

The polymerization in the process of the present invention is carried out preferably at −70 to 150° C., and more preferably at 0 to 50° C.

The polymerization in the process of the present invention is carried out generally for 1 minute to 50 hours, preferably for 30 minutes to 24 hours, and more preferably for 30 minutes to 10 hours, which time is suitably determined generally depending on polymerization temperature, a concentration of a polymerization system, and a conversion ratio to a targeted high-molecular-weight isotactic poly(alkylene oxide).

The isotactic poly(alkylene oxide) of the present invention can be used, for example, as a film. Particularly, the isotactic poly (alkylene oxide) of the present invention has such a high molecular weight that the isotactic poly(alkylene oxide) is high in its thermal decomposition temperature. Therefore, the isotactic poly(alkylene oxide) of the present invention can be suitably used as a heat-resistant film.

### EXAMPLE

The present invention is explained specifically with reference to the following Examples, which do not limit the scope of the present invention.

In the following, regarding cyclohexane, n-heptane and n-hexane, a commercially-available dehydrated solvent manufactured by Kanto Chemical Co., Inc. was used as a polymerization solvent, without any pretreatment; and regarding hexanes, a commercially-available anhydrous solvent manufactured by Aldrich Chemical Company was used as a polymerization solvent, without any pretreatment.

### Reference Example 1

### Production of Catalyst

There were put, in a 200 mL flask, 10 g (42.8 mmol) of 3,5-di-tert-butylsalicylaldehyde, 2.16 g (20 mmol) of 1,2-diaminobenzene, and 100 mL of ethanol. The resultant mixture was agitated, and was refluxed for 4 hours. The mixture was cooled down to room temperature, and was agitated at room temperature for 8 hours, thereby forming a precipitate. The precipitate was filtered off, and the obtained precipitate was dried in a vacuum for 8 hours at room temperature, thereby obtaining 6.27 g (11.6 mmol) of N,N′-bis-(3,5-di-tert-butyl salicylidene)-1,2-benzenediamine in 58% yield.

Then, there were put, in a 200 mL flask, 1.58 g (2.9 mmol) of above-obtained N,N′-bis-(3,5-di-tert-butylsalicylidene)-1,2-benzenediamine, 0.517 g (2.3 mmol) of cobalt (II) acetate tetrahydrate, and 80 mL of ethanol. The resultant mixture was agitated, and was reacted at 80° C. for 30 minutes. The obtained reaction mixture was allowed to stand, thereby cooling down to room temperature. The mixture was subjected to a treatment with a rotary evaporator, thereby removing a solvent from the mixture. There was added 11 mL of methylene chloride to the rotatory evaporator containing a residue, thereby dissolving the residue. There was added slowly 137 mL of hexane to the obtained solution, and the resultant mixture was allowed to stand in a refrigerator for 12 hours, thereby forming a precipitate. The precipitate was filtered off, and was washed three times with each 100 mL of hexane. The washed precipitate was dried in a vacuum for 8 hours at room temperature, thereby obtaining 1.32 g (2.2 mmol) of [N,N′-bis-(3,5-di-tertbutyl salicylidene)-1,2-benzenediamine]cobalt in 96% yield.

Next, 1.0 g of above-obtained [N,N′-bis-(3,5-di-tert-butylsalicylidene)-1,2-benzenediamine]cobalt and 10 mL of methylene chloride (solvent) were put in a 100 mL beaker, in this order, thereby forming a solution. Further, 0.1 mL of acetic acid was added thereto, and the resultant mixture was agitated for 30 minutes. Then, the mixture was allowed to stand in air till complete transpiration of the solvent, thereby obtaining a solid. The solid was washed three times with each 10 mL of pentane, and was dried in a vacuum for 8 hours at room temperature, thereby obtaining 1.04 g (1.58 mmol) of [N,N′-bis-(3,5-di-tert-butylsalicylidene)-1,2-phenylene diamine]cobalt acetate (catalyst) in 96% yield, which is a cobalt complex represented by formula (3), wherein E is a benzenediyl group, R⁵ and R⁷ are a tert-butyl group, R⁶, R⁸ and R⁹ are a hydrogen atom, and X is an acetoxy group.

### Example 1

There was put 56.3 mg of the above-obtained catalyst in a 100 mL flask purged with nitrogen gas, and it was cooled to 5° C. in an ice bath. To the flask, 51.2 mL of cyclohexane and 6 mL of propylene oxide were added in this order. The resultant mixture was stirred for 1 hour, and then hydrochloric acid was added thereto, thereby quenching a polymerization reaction. The mixture was subjected to a treatment with a rotary evaporator to remove volatile materials from the mixture, thereby obtaining a polymer. The polymer was dissolved in acetone, and the resultant solution was allowed to stand in a refrigerator for 12 hours, thereby precipitating a polymer. The precipitated polymer was filtered off, and was dried in a vacuum at 80° C. for 2 hours, thereby obtaining 0.68 g of poly (propylene oxide).

Obtained poly(propylene oxide) was found to have an isotactic triad fraction of 99% or larger measured by ¹³C-NMR, and number-average molecular weight (Mn) of 14,700,000, weight-average molecular weight (Mw) of 26,500,000, and molecular weight distribution (Mw/Mn) of 1.8, measured by a gel permeation chromatography (GPC).

The above number-average molecular weight (Mn), weight-average molecular weight (Mw) and molecular weight distribution (Mw/Mn) were measured according to a gel permeation chromatography (GPC) under the following conditions, with a calibration curve prepared using standard polystyrenes:
GPC equipment: LC-2000 PLUS series manufactured by JASCO Corporation;
column: serially-concatenated column of the following four columns, in this order, all manufactured by Tosoh Corporation,
   TSK-GELG-6000 (trade name),
   G-5000 (trade name),
   G-4000 (trade name), and
   G-3000 HXL (trade name).
measurement temperature: 40° C.;
solvent: tetrahydrofuran; and
sample concentration: 70 mg/mL.

The above ¹³C-NMR was measured under the following conditions;
C-NMR equipment: 400 MHz NMR manufactured by JEOL LTD,
measurement temperature: 23° C.,
solvent: chloroform-d, and
sample amount: 10 mg.

### Example 2

Example 1 was repeated except that 51.2 mL of cyclohexane was changed to 51.2 mL of n-heptane, thereby obtaining 0.58 g of poly(propylene oxide).

Obtained poly(propylene oxide) was found to have number-average molecular weight (Mn) of 2,750,000, weight-average molecular weight (Mw) of 18,400,000, and molecular weight distribution (Mw/Mn) of 6.7.

### Example 3

Example 1 was repeated except that 51.2 mL of cyclohexane was changed to 51.2 mL of n-hexane, thereby obtaining 0.77 g of poly(propylene oxide).

Obtained poly(propylene oxide) was found to have number-average molecular weight (Mn) of 2,530,000, weight-average molecular weight (Mw) of 21,800,000, and molecular weight distribution (Mw/Mn) of 8.6.

### Example 4

There was put 38.5 mg of the above-obtained catalyst in a 100 mL flask purged with nitrogen gas. To the flask was added 37.2 mL of hexanes at room temperature, then was added 20 mL of propylene oxide, and the resultant mixture was stirred for 0.5 hour. Hydrochloric acid was added to the reaction mixture, thereby quenching a polymerization reaction. The mixture was subjected to a treatment with a rotary evaporator to remove volatile materials from the mixture, thereby obtaining a polymer. The polymer was dissolved in acetone, and the resultant solution was allowed to stand in a refrigerator for 12 hours, thereby precipitating a polymer. The precipitated polymer was filtered off, and was dried in a vacuum at 80° C. for 2 hours, thereby obtaining 7.14 g of poly(propylene oxide).

Obtained poly(propylene oxide) was found to have number-average molecular weight (Mn) of 4,030,000, weight-average molecular weight (Mw) of 11,700,000, and molecular weight distribution (Mw/Mn) of 2.9.

### Comparative Example 1

Example 1 was repeated except that 51.2 mL of cyclohexane was changed to 51.2 mL of toluene, thereby obtaining 0.02 g of poly(propylene oxide).

Obtained poly(propylene oxide) was found to have number-average molecular weight (Mn) of 114,000, weight-average molecular weight (Mw) of 490,000, and molecular weight distribution (Mw/Mn) of 4.3.

### Reference Example 2

### Production of Catalyst

To a 200 mL 4-necked flask equipped with a reflux condenser and a thermometer were charged 60.5 g (495 mmol) of 2-ethylphenol and 55.0 g (594 mmol, 1.2 equivalent) of tert-butyl chloride, and the resultant mixture was stirred at room temperature. To the mixture was added portionwise 5.0 g of aluminum trichloride so as to inhibit temperature rise of the mixture. The mixture was stirred for 30 minutes at room temperature, and was further stirred for 30 minutes at 50° C., and then was cooled down to room temperature. The mixture was poured slowly into ice water made of 25 g of ice and 50 mL of water, and the resultant mixture was subjected to extraction two times with each 50 mL of diethyl ether. The obtained diethyl ether layer was dried over sodium sulfate anhydrous, and was concentrated, thereby obtaining 80.4 g of 4-tert-butyl-2-ethylphenol in 85% yield, which was colorless liquid, and was found to be 93% in its purity determined by gas chromatography.

To a 500 mL 4-necked flask equipped with a dropping funnel and a thermometer were charged 80.4 g (418 mmol) of above 4-tert-butyl-2-ethylphenol and 225 ml of dimethylformamide, and the resultant mixture was stirred and cooled down to 15° C. with cold water-bath. To the mixture was added portionwise 73.7 g (414 mmol, 0.99 equivalent) of N-bromosuccinimide so as to inhibit temperature rise of the mixture. The mixture was stirred for 3 hours at 25° C., and was cooled down to 5° C. with an ice-bath. To the mixture cooled down to 5° C. was added ice water made of 68 g of ice and 68 mL of water. The mixture was subjected to extraction two times with each 137 mL of hexane. The obtained hexane layer was dried over sodium sulfate anhydrous, and was concentrated, thereby obtaining 121 g of 2-bromo-4-tert-butyl-6-ethylphenol in 89% yield, which was pale yellow liquid, and was found to be 85% in its purity determined by gas chromatography.

A 1,000 mL 4-necked flask equipped with two dropping funnels, a thermometer and a tree-way cock was purged with nitrogen. To the flask were charged 121 g (445 mmol) of above 2-bromo-4-tert-butyl-6-ethylphenol and 423 mL of dehydrated tetrahydrofuran. The resultant mixture was stirred, and then was cooled down to 5° C. with an ice-bath. To the mixture was added dropwise 178 mL (containing 445 mmol of n-butyllithium) of a hexane solution (concentration: 2.5 mol/L) of n-butyllithium at an addition rate such that the mixture was not raised in its temperature. The mixture was stirred for 30 minutes at 5° C., and then a solution of 43.0 g (534 mmol, 1.20 equivalent) of chloromethyl methyl ether in 181 mL of tetrahydrofuran dehydrated was added dropwise to the mixture at an addition rate such that the mixture was not raised in its temperature. The mixture was stirred for 30 minutes at 5° C., and then its temperature was raised to room temperature. The mixture was further stirred for 30 minutes at room temperature, and was subjected to distillation under reduced pressure to remove volatile materials from the mixture. The resultant mixture was extracted two times with each 300 mL of dehydrated hexane. The obtained hexane layer was concentrated to remove volatile materials, thereby obtaining 114.6 g of 3-bromo-5-tert-butyl-1-ethyl-2-(methoxymethoxy)benzene in 82% yield, which was pale orange color liquid, and was found to be 86% in its purity determined by gas chromatography.

A 2,000 mL 4-necked flask equipped with two dropping funnels, a thermometer and a tree-way cock was purged with nitrogen. To the flask were charged 100 g (285 mmol) of above 3-bromo-5-tert-butyl-1-ethyl-2-(methoxymethoxy)benzene and 1,000 mL of dehydrated tetrahydrofuran. The resultant mixture was stirred, and then was cooled down to −70° C. with a dry ice-ethanol bath. To the mixture was added dropwise 114 mL (containing 285 mmol of n-butyllithium) of a hexane solution (concentration: 2.5 mol/L) of n-butyllithium at an addition rate such that the mixture was not raised in its temperature. The mixture was agitated for 30 minutes at 5° C., and then a solution of 34.6 g (342 mmol, 0.91 equivalent) of N,N-diethylformamide in 25 mL of dehydrated tetrahydrofuran was added dropwise to the mixture at an addition rate such that the mixture was not raised in its temperature. The mixture was stirred for 30 minutes at −70° C., then its temperature was raised by itself up to room temperature without the dry ice-ethanol bath, and was further stirred for 30 minutes at room temperature. To the mixture was added 1N-hydrochloric acid, thereby adjusting its pH to 6. The resultant mixture was extracted two times with each 500 mL of diethyl ether. The obtained diethyl ether layer was dried over magnesium sulfate anhydrous, and was concentrated, thereby obtaining 93.2 g of 5-tert-butyl-3-ethyl-2-(methoxymethoxy)benzaldehyde in 59% yield, which was red color liquid, and was found to be 45% in its purity determined by gas chromatography.

To a flask equipped with a reflux tube was charged 80 g of above 5-tert-butyl-3-ethyl-2-(methoxymethoxy)benzaldehyde, and 160 mL of methanol was added thereto. To the resultant mixture was added 36.3 g of a styrene-divinylbenzene copolymer (AMBERLYST 15), and the mixture was refluxed for 2 hours. The mixture was filtered with sellite, and was concentrated, thereby obtaining 64.5 g of 5-tert-butyl-3-ethylsalicylaldehyde in 99% yield, which was red color liquid, and was found to be 46% in its purity determined by gas chromatography.

To a 100 mL flask were charged 5.0 g (11.1 mmol) of above 5-tert-butyl-3-ethylsalicylaldehyde, 0.54 g (5.0 mmol) of 1,2-diaminobenzene, and 40 mL of ethanol. The mixture was stirred, then was refluxed for 3 hours, and then was cooled down to room temperature. The mixture was subjected to distillation under reduced pressure to remove volatile materials, and was further subjected to distillation at 120° C. under pressure of 0.45 kPa to distil away volatile materials, thereby obtaining 1.50 g of N,N′-bis-(5-tert-butyl-3-ethylsalicylidene)-1,2-phenylenediamine in 28% yield, which was orange color viscous liquid.

To a 100 mL flask equipped with a cooler were charged 0.20 g (0.41 mmol) of above N,N′-bis-(5-tert-butyl-3-ethylsalicylidene)-1,2-phenylene diamine, 0.082 g (0.33 mmol) of cobalt (II) acetate tetra-hydrate, and 12 mL of ethanol. The resultant mixture was stirred, and then was subjected to a reaction at a reflux temperature for 60 minutes. The reaction mixture was allowed to stand, thereby cooling down to room temperature. The mixture was subjected to distillation with a rotary evaporator to remove a solvent, and then 2 mL of methylene chloride was added thereto. To the resultant solution was added slowly 15 mL of hexane, and the obtained mixture was allowed to stand in a refrigerator for 12 hours, thereby precipitating a solid. The precipitated solid was separated by filtration, then was washed two times with each 10 mL of hexane, and was dried in a vacuum for two hours at room temperature, thereby obtaining 0.19 g (2.2 mmol) of [N,N′-bis-(5-tert-butyl-3-ethylsalicylidene)-1,2-phenylenediamine]cobalt in quantitative yield.

To a 20 mL Schlenk flask were charged 0.19 g of above [N,N′-bis-(5-tert-butyl-3-ethylsalicylidene)-1,2-phenylene diamine]cobalt and 10 mL of methylene chloride, thereby preparing a solution. To the solution was added 0.022 mL of acetic acid, and the resultant mixture was stirred for 30 minutes. The mixture was allowed to stand in air to evaporate a solvent, thereby obtaining a solid. The solid was washed three times with each 2 mL of pentane, and then was dried in vacuum for two hours at room temperature, thereby obtaining 0.08 g (0.13 mmol) of [N,N′ (5-tert-butyl-3-ethylsalicylidene)-1,2-phenylene diamine]cobalt acetate represented by formula (3) in 38% yield, wherein E is a 1,2-benzenediyl group; R⁵ is an ethyl group; R⁷ is a tert-butyl group; R⁶, R⁸ and R⁹ groups are a hydrogen atom; and X is an acetoxy group.

### Comparative Example 2

Example 4 was repeated except that 56.3 mg of [N,N′-bis-(3,5-di-tert-butylsalicylidene)-1,2-phenylene diamine]cobalt acetate was changed to 24.7 mg of [N,N′-bis-(5-tert-butyl-3-ethylsalicylidene)-1,2-phenylene diamine]cobalt acetate prepared in Referenced Example 2 and the polymerization time was changed from 0.5 hour and 24 hours, thereby obtaining 0.40 g of poly(propylene oxide).

Obtained poly(propylene oxide) was found to have number-average molecular weight (Mn) of 6,400, weight-average molecular weight (Mw) of 227,000, and molecular weight distribution (Mw/Mn) of 35.3.

1. An isotactic poly(alkylene oxide) containing a repeating unit represented by following formula (1), and having an isotactic triad fraction (mm) of 66 to 100% measured by ¹³C-nuclear magnetic resonance analysis (¹³C-NMR), and number-average molecular weight (Mn) of 500,000 or more: 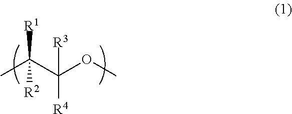
wherein R¹ and R² are a hydrogen atom or a hydrocarbyl group having 1 to 20 carbon atoms, and are different from each other; and R³ and R⁴ are independently of each other a hydrogen atom or a hydrocarbyl group having 1 to 20 carbon atoms.

2. The isotactic poly(alkylene oxide) according to claim 1, wherein the number-average molecular weight (Mn) is above 500,000 but does not exceed 20,000,000.

3. The isotactic poly(alkylene oxide) according to claim 1, wherein the number-average molecular weight (Mn) is above 2,000,000 but does not exceed 15,000,000.

4. The isotactic poly(alkylene oxide) according to claim 1, wherein R¹ or R² is a hydrogen atom, and R³ and R⁴ are a hydrogen atom.

5. The isotactic poly(alkylene oxide) according to claim 1, wherein the isotactic poly(alkylene oxide) contains 90 to 100% of the repeating unit represented by following formula (1).

6. A process for producing an isotactic poly(alkylene oxide) containing a repeating unit represented by following formula (1), and having an isotactic triad fraction (mm) of 66 to 100% measured by ¹³C-nuclear magnetic resonance analysis (¹³C-NMR), and number-average molecular weight (Mn) of 500,000 or more, the process comprising the step of polymerizing an epoxide represented by following formula (2) in the presence of a catalyst and an aliphatic compound and/or alicyclic compound: 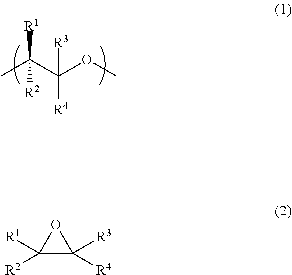
wherein R¹ and R² are a hydrogen atom or a hydrocarbyl group having 1 to 20 carbon atoms, and are different from each other; and R³ and R⁴ are independently of each other a hydrogen atom or a hydrocarbyl group having 1 to 20 carbon atoms.

7. The process according to claim 6, wherein the number-average molecular weight (Mn) is above 500,000 but does not exceed 20,000,000.

8. The process according to claim 6, wherein R¹ or R² is a hydrogen atom, and R³ and R⁴ are a hydrogen atom.

9. The process according to claim 6, wherein the aliphatic compound is n-hexane or n-heptane, and the alicyclic compound is cyclohexane.

10. The process according to claim 6, wherein the catalyst is a cobalt complex represented by following formula (3): 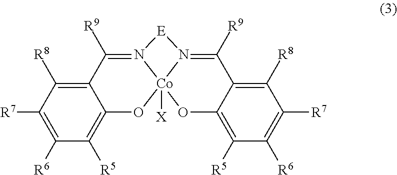
wherein E is a hydrocarbylene group having 1 to 20 carbon atoms; R⁵ to R⁹ are independently of one another a hydrogen atom, a halogen atom, a hydrocarbyl group having 1 to 20 carbon atoms, a hydrocarbylsilyl group having 1 to 20 carbon atoms, a hydrocarbyloxy group having 1 to 20 carbon atoms, a dihydrocarbylamino group having 2 to 20 carbon atoms, an azido group, or a cyano group; and X is a hydroxyl group, a halogen atom, a hydrocarbyloxy group having 1 to 20 carbon atoms, an acyloxy group having 1 to 20 carbon atoms, a dihydrocarbylamino group having 2 to 20 carbon atoms, an azido group, or a cyano group.
